(19) United States
(12) Patent Application Publication
(10) Pub. No.: US 2024/0067890 A1
(43) Pub. Date: Feb. 29, 2024

(54) PROCESS FOR UPGRADING AN OXYGENATE FEEDSTOOK INTO HYDROCARBON FRACTIONS AND OTHER APPLICATIONS

(71) Applicant: COMPAÑÍA ESPAÑOLA DE PETRÓLEOS, S.A., Madrid (ES)

(72) Inventors: Rafael LARRAZ MORA, Madrid (ES); Carlos AYUSO MARTÍN, Madrid (ES); Juana María FRONTELA DELGADO, Madrid (ES); Fernando Aridane RODRÍGUEZ DE LA NUEZ, Madrid (ES)

(21) Appl. No.: 18/260,455

(22) PCT Filed: Nov. 14, 2022
(86) PCT No.: PCT/EP2022/081836

§ 371 Date: Jul. 5, 2023

(30) Foreign Application Priority Data
Nov. 12, 2021 (EP) 21383031.8

(51) Int. Cl. C10G 65/12

(52) U.S. Cl. CPC C10G 65/12; C10G 2300/1011; C10G 2300/207; C10G 2400/08

(57) ABSTRACT

A process plant and a process for production of a n-paraffinic hydrocarbon fraction from an oxygenate feedstock such as a renewable feedstock, includes hydrodeoxygenation of the feedstock followed by fractionation of the product thus obtained to provide at least two fractions. The heavy fraction is recycled to an hydrocracking reactor positioned downstream the fractionation section and a lighter fraction is separated to provide the n-paraffinic rich hydrocarbon fraction of a defined carbon range. Optionally, other hydrocarbon fractions obtainable by the provided process and plant may be further transformed into jet fuel or other valuable products.

### FIELD OF THE INVENTION

The invention finds application in the petrochemical and related industries. More particularly, the invention concerns a process and a plant for producing a n-paraffinic rich fraction from an oxygenate feedstock. The provided process and plant may also be adapted for producing other hydrocarbon fractions such as fractions aimed at the obtention of jet fuel.

### BACKGROUND OF THE INVENTION

Normal paraffins, that is linear paraffins, are important raw materials for the manufacture of biodegradable detergents, synthetic fatty acids, secondary alcohols, chloroparaffins, single cell protein, certain pharmaceutical products and many other industrial items.

Normal paraffins have been traditionally produced from kerosene extracted from crude oil. Due to the growing environmental concerns over fossil fuel extraction and economic concerns over exhausting fossil fuel deposits, it has been proposed to use renewable sources for producing linear paraffins. For instance, WO2013141979 A1 discloses a process for producing linear paraffins from a natural oil which involves deoxygenating the natural oil to form a stream comprising paraffins, purifying the stream comprising paraffins to form a purified stream comprising paraffins, and separating a first fraction of paraffin product from the purified stream comprising paraffins. This process allows preparing paraffins of the same length as the starting oils used.

If it is desired to obtain paraffins shorter than a given feedstock, a hydrocraking stage must be performed. However, it has been reported that hydrocracking to a lower carbon chain length from a longer chain length is a very inefficient way to produce linear paraffins. In particular, hydrocraking has been found to result in almost exclusively branched paraffins so very little of a hydrocracked product material would result in normal paraffins. Therefore to produce linear paraffins of “short” chain (e.g. C10-C13) it is considered as highly preferable to use oils with large amounts of C10, C12 and C14 carbon chain length fatty acids, such as coconut oil, palm kernel oil and babassu oil (see WO2014200897 A1).

On the other hand, conversion of renewables in hydroprocessing has generally been focused on making diesel, since the paraffins corresponding to the typical fatty acids of biological materials such as vegetable oils and animal fats (C14, C16 and C18) typically boil from 250° C. to 320° C., corresponding well with typical diesel products boiling from 150° C. to 380° C. However, jet fuel products require a boiling range of 120° C. to 300° C. or 310° C., which means that the heavy part of a paraffins from renewable feedstocks needs to be converted into lighter materials to produce only jet fuel.

### DESCRIPTION OF THE INVENTION

The present disclosure relates to a process and a plant primarily aimed at producing linear paraffins from an oxygenate feedstock. Optionally, other hydrocarbon fractions obtainable by the provided process and plant may be further transformed into jet fuel or other valuable products.

Now according to the present disclosure it is proposed to carry out n-paraffin production in an innovative configuration, where the feed is hydrodeoxygenated in the first stage, and after removal of sour gases the product is fractionated so that the heavy fraction is directed to the pre-stage for conversion over a hydrocracking catalyst whereas at least one kerosene fraction is directed to a separation step to provide a n-paraffinic rich hydrocarbon fraction and an iso-paraffinic rich hydrocarbon fraction. An amount of the kerosene fraction may be used for jet fuel production in an optional further stage, which typically includes hydrodearomatization and/or hydroisomerization to improve the freezing point of the kerosene fraction. Besides the iso-paraffinic rich hydrocarbon fraction may optionally be also combined with the kerosene fraction either before or after the optional hydrodearomatization and/or hydroisomerization stage with the aim of ensuring the jet fuel quality. By this process, a very efficient technique for producing n-paraffins and optionally jet fuel is achieved, as only the stream heavier than kerosene contacts the hydrocracking catalyst.

In the following the abbreviation ppmₘₒₗₐᵣ shall be used to signify atomic parts per million.

In the following the abbreviation ppmᵥ shall be used to signify volumetric parts per million, e.g. molar gas concentration.

In the following the abbreviation % wt shall be used to signify weight percentage.

In the following the abbreviation vol/vol % shall be used to signify volume percentage for a gas.

In the following the term renewable feedstock or hydrocarbon shall be used to indicate a feedstock or hydrocarbon originating from biological sources or waste recycle. Recycled waste of fossil origin such as plastic shall also be construed as renewable.

In the following the term hydrodeoxygenation shall be used to signify removal of oxygen from oxygenates by formation of water in the presence of hydrogen, as well as removal of oxygen from oxygenates by formation of carbon oxides in the presence of hydrogen.

In the following, the term topology of a molecular sieve is used in the sense described in the “Atlas of Zeolite Framework Types,” Sixth Revised Edition, Elsevier, 2007, and three letter framework type codes are used in accordance herewith.

As used herein, any expression that refers to a range of carbon atoms (e.g. Ca-Cb; Ca or shorter) for a given compound (hydrocarbon, paraffin . . . ) means at least a single compound having a number of carbon atoms within such a range, or a mixture of such compounds. By way of illustration, a paraffin in the range of C10-C13 includes a C10 paraffin, a C11 paraffin, a C12 paraffin, a C13 paraffin or one or more of such paraffins.

A broad aspect of the present disclosure relates to a process for production of a n-paraffinic hydrocarbon fraction (229) from an oxygenate feedstock, comprising the steps of:
a. combining the feedstock (202) with an amount of a hydrocracked intermediate product (206, 206′) or another quenching product (203) to form a combined feedstock (204), directing the combined feedstock (204) to contact a material catalytically active in hydrodeoxygenation (HDO) under hydrodeoxygenation conditions to provide a hydrodeoxygenated intermediate product (212),
b. fractionating at least an amount of said hydrodeoxygenated intermediate product (212), optionally combined with an amount of hydrocracked intermediate product (206, 206″), in
   b1. at least two fractions, including a first fraction (226) of which at least 90% boils above a defined boiling point (bp1), a second fraction (224) of which at least 90% boils below said defined boiling point (bp1) and an optional naphtha fraction (222), or
   b2. at least three fractions, including a first fraction (226) of which at least 90% boils above a defined higher boiling point (bp1), a second fraction (224 —) of which at least 90% boils below said defined higher boiling point (bp1) and at least 90% boils above a defined lower boiling point (bp2), a third fraction (227) of which at least 90% boils below said defined lower boiling point (bp2) and an optional naphtha fraction (222);
c. directing at least an amount of said first fraction (226) to contact a material catalytically active in hydrocracking (HDC) under hydrocracking conditions to provide the hydrocracked intermediate product (206), wherein said hydrocracked intermediate product (206) is either
   c1. combined with the oxygenate feedstock (202) to form the combined feedstock (204) as defined in step a, or
   c2. combined with the hydrodeoxygenated intermediate product (212) as defined in step b, or
   c3. split into the two fractions of hydrocracked intermediate product (206′ and 206″), wherein the hydrocracked intermediate product (206′) is combined with the oxygenate feedstock (202) to form the combined feedstock (204) as defined in step a and the hydrocracked intermediate product (206″) is combined with the hydrodeoxygenated intermediate product (212) as defined in step b,
   d. if the step b is as defined in b1, optionally splitting the second fraction (224) into at least two fractions (224′ and 224″), and
   e. separating the fraction (224), (224′) or (227) to provide the n-paraffinic rich hydrocarbon fraction of a defined carbon range (229) and an iso-paraffinic rich hydrocarbon fraction (228).

This process has the associated benefit of being well suited for efficiently converting the upper-boiling point of an oxygenate feedstock such as a renewable feedstocks to lower boiling products, such as non-fossil kerosene. Besides, it is possible to obtain paraffins with any desired chain length from starting materials having longer chain lengths based upon the oxygenate feedstock and the hydrocraking conditions used. In this context, contrary to the prior art teachings (e.g. WO2014200897 A1), hydrocracking conditions may be adjusted to yield a substantial proportion of straight chain components (n-paraffins). A further benefit of the propose process is that fractions of the lower boiling products and the iso-paraffinic rich hydrocarbon fraction may be used for jet fuel production.

Step b comprises subjecting the intermediate product coming from the hydrodeoxygenation (212) either alone or combined with an amount of hydrocracked intermediate product coming from the hydrocracking (206, 206″) to separation according to boiling point, to provide a fraction (224, 227) comprising paraffins of a defined carbon range. The boiling point cut will be adjusted based on the length desired for the n-paraffins.

In a further embodiment in step b1, the boiling point (bp1) is about 300° C., thus obtaining a fraction (224) mainly comprising C₁₆ paraffins or shorter.

In a further embodiment in step b1, the boiling point (bp1) is about 271° C., thus obtaining a fraction (224) mainly comprising C₁₅ paraffins or shorter.

In a further embodiment in step b1, the boiling point (bp1) is about 234° C., thus obtaining a fraction (224) mainly comprising C₁₃ paraffins or shorter.

In a further embodiment step b1 comprises separating the hydrodeoxygenated intermediate product (212), optionally combined with an amount of hydrocracked intermediate product (206, 206″), according to boiling point, to provide an intermediate fraction (224) having T10 above 174° C. and final boiling point (bp1) below 300° C. according to ASTM D86, corresponding substantially with C₁₀₋₁₆ paraffins, with the associated benefit of the product of such a process fulfilling boiling point specifications of the renewable jet fuel specification ASTM D7566.

In a further embodiment step b1 comprises separating the hydrodeoxygenated intermediate product (212), optionally combined with an amount of hydrocracked intermediate product (206, 206″), according to boiling point, to provide an intermediate fraction (224) having T10 above 174° C. and final boiling point (bp1) below 271° C. according to ASTM D86, corresponding substantially with C₁₀₋₁₅ paraffins.

In a further embodiment step b1 comprises separating the hydrodeoxygenated intermediate product (212), optionally combined with an amount of hydrocracked intermediate product (206, 206″), according to boiling point, to provide an intermediate fraction (224) having T10 above 174° C. and final boiling point (bp1) below 234° C. according to ASTM D86, corresponding substantially with C₁₀₋₁₃ paraffins.

In a further embodiment in step b2, the boiling point (bp1) is about 300° C. and the boiling point (bp2) is about 271° C., thus obtaining a fraction (227) mainly comprising C15 paraffins or shorter and a fraction (224 —) mainly comprising C₁₆ paraffins.

In a further embodiment in step b2, the boiling point (bp1) is about 300° C. and the boiling point (bp2) is about 234° C., thus obtaining a fraction (227) mainly comprising C13 paraffins or shorter and a fraction (224 —) mainly comprising paraffins in the carbon range C₁₄-C₁₆.

In a further embodiment in step b2, the boiling point (bp1) is about 271° C. and the boiling point (bp2) is about 234° C., thus obtaining a fraction (227) mainly comprising C13 paraffins or shorter and a fraction (224 —) mainly comprising paraffins in the carbon range C14-015.

In a further embodiment step b2 comprises separating the hydrodeoxygenated intermediate product (212), optionally combined with an amount of hydrocracked intermediate product (206, 206″), according to boiling point, to provide an intermediate product (224 —) having T10 above 271° C. and final boiling point below 300° C. according to ASTM D86, corresponding substantially with C16 paraffins, and an intermediate product (227) having T10 above 174° C. and final boiling point below 271° C. according to ASTM D86, corresponding substantially with C₁₀₋₁₅ paraffins.

In a further embodiment step b2 comprises separating the hydrodeoxygenated intermediate product (212), optionally combined with an amount of hydrocracked intermediate product (206, 206″), according to boiling point, to provide an intermediate product (224 —) having T10 above 234° C. and final boiling point below 300° C. according to ASTM D86, corresponding substantially with C₁₄₋₁₆ paraffins, and an intermediate product (227) having T10 above 174° C. and final boiling point below 234° C. according to ASTM D86, corresponding substantially with C₁₀₋₁₃ paraffins.

In a further embodiment step b2 comprises separating the hydrodeoxygenated intermediate product (212), optionally combined with an amount of hydrocracked intermediate product (206, 206″), according to boiling point, to provide an intermediate product (224 —) having T10 above 234° C. and final boiling point 271° C. according to ASTM D86, corresponding substantially with C₁₄₋₁₅ paraffins, and an intermediate product (227) having T10 above 174° C. and final boiling point below 234° C. according to ASTM D86, corresponding substantially with C₁₀₋₁₃ paraffins.

In a further embodiment, the fraction (224) in step b1 or the fraction (227) in step b2 comprises paraffins mainly in the carbon range C₁₀₋₁₃ or C₁₀₋₁₅ or C₁₀₋₁₆.

In a further embodiment step b1 comprises separating the hydrodeoxygenated intermediate product (212), optionally combined with an amount of hydrocracked intermediate product (206, 206″), according to boiling point, to provide at least the following fractions: a first fraction (226) of which at least 90% boils above a defined boiling point (bp1), a second fraction (224) of which at least 90% boils below said defined boiling point (bp1), a naphtha fraction (222) and a light overhead fraction (220).

In a further embodiment step b2 comprises separating the hydrodeoxygenated intermediate product (212), optionally combined with an amount of hydrocracked intermediate product (206, 206″), according to boiling point, to provide at least the following fractions: a first fraction (226) of which at least 90% boils above a defined higher boiling point (bp1), a second fraction (224 —) of which at least 90% boils below said defined higher boiling point (bp1) and at least 90% boils above a defined lower boiling point (bp2), a third fraction (227) of which at least 90% boils below said defined lower boiling point (bp2), a naphtha fraction (222) and a light overhead fraction (220).

As used herein, the naphtha fraction (222) is a fraction lighter (i.e. shorter chain, lower boiling point) than (224) or (227) and heavier (i.e. longer chain, higher boiling point) than the light overhead fraction (220).

In a further embodiment the total volume of hydrogen sulfide relative to the volume of molecular hydrogen in the gas phase of the total stream directed to contact the material catalytically active in hydrodeoxygenation is at least 50 ppmᵥ, 100 ppmᵥ or 200 ppmᵥ, possibly originating from an added stream comprising one or more sulfur compounds, such as dimethyl disulfide or fossil fuels, with the associated benefit of ensuring stable operation of a material catalytically active in hydrodeoxygenation comprising a sulfided base metal, if the feedstock comprises an insufficient amount of sulfur.

In a further embodiment said oxygenate feedstock (202) consists of or comprises a renewable feedstock comprising a natural oil or fat. Preferably, the renewable feedstock comprises at least 50% wt triglycerides or fatty acids, with the associated benefit of such a feedstock being more environmentally friendly than wholly fossil feedstocks and highly suited for providing a jet fuel with excellent properties.

The oxygenate feedstock (202) must comprise hydrocarbon moieties having a chain length longer than that of the target n-paraffinic rich hydrocarbon fraction (229). By way of illustration, oxygenate feedstocks such as a renewable feedstock comprising hydrocarbon moieties of 14 carbon atoms or more are especially suitable for producing n-paraffins in the range of C₁₀-C₁₃, hydrocarbon moieties of 16 carbon atoms or more are especially suitable for producing n-paraffins in the range of C₁₀-C₁₅ and hydrocarbon moieties of 17 carbon atoms or more are especially suitable for producing n-paraffins in the range of C₁₀-C₁₆.

In a further embodiment hydrodeoxygenation conditions involve a temperature in the interval 250-400° C. (e.g. 350-390° C. or 350-375° C.), a pressure in the interval 30-150 Bar (e.g. 50-100 or 50-75 Bar), and a liquid hourly space velocity (LHSV) in the interval 0.1-2.2 (e.g. 1-2 or 1.5-2) and wherein the material catalytically active in hydrodeoxygenation comprises molybdenum or possibly tungsten, optionally in combination with nickel and/or cobalt, supported on a carrier comprising one or more refractory oxides, such as alumina, silica or titania, with the associated benefit of such process conditions being well suited for cost effective removal of heteroatoms, especially oxygen from a renewable feedstock. A particular catalyst for hydrodeoxygenating is Alumina with Co and Mo.

In a further embodiment hydrocracking conditions involve a temperature in the interval 250-410° C. (e.g. 350-405° C.), a pressure in the interval 30-150 Bar (e.g. 50-100 or 50-75 Bar), and a liquid hourly space velocity (LHSV) in the interval 0.5-4 (e.g. 0.75-2), optionally together with intermediate cooling by quenching with cold hydrogen, feed or product and wherein the material catalytically active in hydrocracking comprises (a) one or more active metals taken from the group platinum, palladium, nickel, cobalt, tungsten and molybdenum, (b) an acidic support taken from the group of a molecular sieve showing high cracking activity, and having a topology such as MFI, BEA and FAU and amorphous acidic oxides such as silica-alumina and (c) a refractory support such as alumina, silica or titania, or combinations thereof, with the associated benefit of such process conditions being highly suited for adjusting the boiling point of a product to match the kerosene boiling point range. Particular catalysts for hydrocracking are Y Zeolite with Ni, Mo and alumina as binder; Alumina with Ni and Mo; and Y Zeolite with Ni and W and silica as binder.

In a further embodiment the process conditions are selected such that the conversion, defined as the difference in the amount of material boiling above 300° C. in said hydrocracked intermediate product (206) and the amount of material boiling above 300° C. in fraction (226), relative to the amount of material boiling above 300° C. in fraction (226), is above 20%, 50% or 80%, with the associated benefit of providing a process with full or substantially full overall conversion, while avoiding excessive conditions and excessive yield loss.

When step b is as defined in b1, the second fraction (224) coming from the fractionating step can be split into at least two fractions (224′ and 224″). The fraction (224) or the fraction (224′) is then directed to the separator section (N/I SEP). When step b is as defined in b2, the third fraction (227) is directed to the separator section (N/I SEP). In the separator section (N/I SEP), the fraction (224), (224′) or (227) is separated to provide the n-paraffinic rich hydrocarbon fraction (229) and the iso-paraffinic rich hydrocarbon fraction (228). Selective separation of hydrocarbons by degree of branching may be conveniently performed by adsorption processes using for instance molecular sieves. This technique allows the selective separation of normal and iso-paraffins based on the differences on molecular size. Other separators known in the art are suitable for use herein as well.

The expression n-paraffinic rich hydrocarbon fraction (229) shall be understood broadly to signify that said fraction is enriched in normal paraffins (and consequently depleted in iso paraffins) relative to the precursory fraction (224), (224′) or (227) before the separation step e. For instance, the resulting n-paraffinic rich hydrocarbon fraction (229) may comprise above or equal to about 5%, 10%, 15%, 20%, 25%, 30%, 35%, 40%, 45%, 50%, 55%, 60%, 65%, 70%, 75%, 80%, 85%, 90%, 95% or even 100% of n-paraffins, based on the total content of paraffins (normal and iso).

Analogously, the expression iso-paraffinic rich hydrocarbon fraction (228) shall be understood broadly to signify that said fraction is enriched in iso paraffins (and consequently depleted in normal paraffins) relative to the precursory fraction (224), (224′) or (227) before the separation step e. For instance, the resulting iso-paraffinic rich hydrocarbon fraction (228) may comprise above or equal to about 5%, 10%, 15%, 20%, 25%, 30%, 35%, 40%, 45%, 50%, 55%, 60%, 65%, 70%, 75%, 80%, 85%, 90%, 95% or even 100% of iso-paraffins, based on the total content of paraffins (normal and iso).

The present invention also refers to the co-production of a n-paraffinic hydrocarbon fraction (229) and jet fuel or a jet fuel blend component from an oxygenate feedstock (202) fulfilling standard jet fuel specifications, e.g. ASTM D7566.

In a particular embodiment, at least an amount of said fraction (224″) or (224′″) and/or an external paraffin fraction not deriving from the hydrodeoxygenated intermediate product (212) is optionally combined with at least an amount of the iso-paraffinic hydrocarbon fraction (228) and/or with at least an amount of the naphtha fraction (222), and then hydroisomerized and hydrodearomatized, and the resulting product is suitable for use as jet fuel or as a jet fuel blend component. See FIGS. 2, 5, 7 and 9.

In a further embodiment at least an amount of said fraction (224″) or (224′″) and/or an external paraffin fraction not deriving from the hydrodeoxygenated intermediate product (212), optionally combined with at least an amount of the iso-paraffinic hydrocarbon fraction (228) and/or with at least an amount of the naphtha fraction (222) to form a combined fraction (230), is directed to contact a material catalytically active in hydrodearomatization (HDA) under hydrodearomatization conditions to provide a hydrodearomatized product, which may be contacted with a material catalytically active in hydroisomerization (HDI) under hydroisomerization conditions to provide a hydroisomerized and hydrodearomatized product (218). Hydroisomerization (HDI) is referred to as ISOM in the figures.

In a further embodiment at least an amount of said fraction (224″) or (224′″) and/or an external paraffin fraction not deriving from the hydrodeoxygenated intermediate product (212), optionally combined with at least an amount of the iso-paraffinic hydrocarbon fraction (228) and/or with at least an amount of the naphtha fraction (222) to form a combined fraction (230), is directed to contact a material catalytically active in hydroisomerization (HDI) under hydroisomerization conditions to provide a hydroisomerized product, which may be contacted with a material catalytically active in hydrodearomatization (HDA) under hydrodearomatization conditions to provide a hydroisomerized and hydrodearomatized product (218).

In a further embodiment at least an amount of said fraction (224″) or (224′″) and/or an external paraffin fraction not deriving from the hydrodeoxygenated intermediate product (212), optionally combined with at least an amount of the iso-paraffinic hydrocarbon fraction (228) and/or with at least an amount of the naphtha fraction (222) to form a combined fraction (230), is directed to contact a material catalytically active in hydroisomerization (HDI) under hydroisomerization conditions and in hydrodearomatization (HDA) under hydrodearomatization conditions to provide a hydroisomerized and/or hydrodearomatized product (218).

Additionally or alternatively, the naphtha fraction (222) may be used downstream the hydroisomerization (HDI) and hydrodearomatization (HDA) section for jet fuel production.

In a particular embodiment, at least an amount of said fraction (224″) or (224′″) and/or an external paraffin fraction not deriving from the hydrodeoxygenated intermediate product (212) is optionally combined with at least an amount of the iso-paraffinic hydrocarbon fraction (228), then hydroisomerized and hydrodearomatized, and then optionally combined with at least an amount of the naphtha fraction (222), and the resulting product is suitable for use as jet fuel or as a jet fuel blend component.

In a further embodiment at least an amount of said fraction (224″) or (224′″) and/or an external paraffin fraction not deriving from the hydrodeoxygenated intermediate product (212), optionally combined with at least an amount of the iso-paraffinic hydrocarbon fraction (228) to form a combined fraction (230), is directed to contact a material catalytically active in hydrodearomatization (HDA) under hydrodearomatization conditions to provide a hydrodearomatized product, which may be contacted with a material catalytically active in hydroisomerization (HDI) under hydroisomerization conditions to provide a hydroisomerized and hydrodearomatized product (218) which may be optionally combined with at least an amount of the naphtha fraction (222) to provide a further hydroisomerized and hydrodearomatized product (218′).

In a further embodiment at least an amount of said fraction (224″) or (224′″) and/or an external paraffin fraction not deriving from the hydrodeoxygenated intermediate product (212), optionally combined with at least an amount of the iso-paraffinic hydrocarbon fraction (228) to form a combined fraction (230), is directed to contact a material catalytically active in hydroisomerization (HDI) under hydroisomerization conditions to provide a hydroisomerized product, which may be contacted with a material catalytically active in hydrodearomatization (HDA) under hydrodearomatization conditions to provide a hydroisomerized and hydrodearomatized product (218) which may be optionally combined with at least an amount of the naphtha fraction (222) to provide a further hydroisomerized and hydrodearomatized product (218′).

In a further embodiment at least an amount of said fraction (224″) or (224′″) and/or an external paraffin fraction not deriving from the hydrodeoxygenated intermediate product (212), optionally combined with at least an amount of the iso-paraffinic hydrocarbon fraction (228) to form a combined fraction (230), is directed to contact a material catalytically active in hydroisomerization (HDI) under hydroisomerization conditions and in hydrodearomatization (HDA) under hydrodearomatization conditions to provide a hydroisomerized and/or hydrodearomatized product (218) which may be optionally combined with at least an amount of the naphtha fraction (222) to provide a further hydroisomerized and hydrodearomatized product (218′).

In a particular embodiment, at least an amount of said fraction (224″) or (224′″), optionally combined with at least an amount of the naphtha fraction (222), is hydroisomerized and/or hydrodearomatized, and then is optionally combined with at least an amount of the iso-paraffinic hydrocarbon fraction (228) and/or an external iso-paraffinic rich hydrocarbon fraction not deriving from the hydrodeoxygenated intermediate product (212), and the resulting product is suitable for use as jet fuel or as a jet fuel blend component. See FIGS. 3, 6, 8 and 10.

In a further embodiment at least an amount of said fraction (224″) or (224′″), optionally combined with at least an amount of the naphtha fraction (222), is directed to contact a material catalytically active in hydrodearomatization (HDA) under hydrodearomatization conditions to provide a hydrodearomatized product, which may be contacted with a material catalytically active in hydroisomerization (HDI) under hydroisomerization conditions to provide a hydroisomerized and hydrodearomatized product (218) which may be optionally combined with the iso-paraffinic rich hydrocarbon fraction (228) and/or an external iso-paraffinic rich hydrocarbon fraction not deriving from the hydrodeoxygenated intermediate product (212) to provide a further hydroisomerized and hydrodearomatized product (218′).

In a further embodiment at least an amount of said fraction (224″) or (224′″), optionally combined with at least an amount of the naphtha fraction (222), is directed to contact a material catalytically active in hydroisomerization (HDI) under hydroisomerization conditions to provide a hydroisomerized product, which may be contacted with a material catalytically active in hydrodearomatization (HDA) under hydrodearomatization conditions to provide a hydroisomerized and hydrodearomatized product (218) which may be optionally combined with the iso-paraffinic rich hydrocarbon fraction (228) and/or an external iso-paraffinic rich hydrocarbon fraction not deriving from the hydrodeoxygenated intermediate product (212) to provide a further hydroisomerized and hydrodearomatized product (218′).

In a further embodiment at least an amount of said fraction (224″) or (224′″), optionally combined with at least an amount of the naphtha fraction (222), is directed to contact a material catalytically active in hydroisomerization (HDI) under hydroisomerization conditions and in hydrodearomatization (HDA) under hydrodearomatization conditions to provide a hydroisomerized and hydrodearomatized product (218) which may be optionally combined with the iso-paraffinic rich hydrocarbon fraction (228) and/or an external iso-paraffinic rich hydrocarbon fraction not deriving from the hydrodeoxygenated intermediate product (212) to provide a further hydroisomerized and hydrodearomatized product (218′).

Additionally or alternatively, the naphtha fraction (222) may be used downstream the hydroisomerization (HDI) and hydrodearomatization (HDA) section for jet fuel production.

In a particular embodiment, at least an amount of said fraction (224″) or (224′″) is hydroisomerized and/or hydrodearomatized, and then is optionally combined with at least an amount of the iso-paraffinic hydrocarbon fraction (228) and/or an external iso-paraffinic rich hydrocarbon fraction not deriving from the hydrodeoxygenated intermediate product (212) and/or at least an amount of the naphtha fraction (222), and the resulting product is suitable for use as jet fuel or as a jet fuel blend component.

In a further embodiment at least an amount of said fraction (224″) or (224′″) is directed to contact a material catalytically active in hydrodearomatization (HDA) under hydrodearomatization conditions to provide a hydrodearomatized product, which may be contacted with a material catalytically active in hydroisomerization (HDI) under hydroisomerization conditions to provide a hydroisomerized and hydrodearomatized product (218) which may be optionally combined with the iso-paraffinic rich hydrocarbon fraction (228) and/or an external iso-paraffinic rich hydrocarbon fraction not deriving from the hydrodeoxygenated intermediate product (212) and/or at least an amount of the naphtha fraction (222) to provide a further hydroisomerized and hydrodearomatized product (218′).

In a further embodiment at least an amount of said fraction (224″) or (224′″) is directed to contact a material catalytically active in hydroisomerization (HDI) under hydroisomerization conditions to provide a hydroisomerized product, which may be contacted with a material catalytically active in hydrodearomatization (HDA) under hydrodearomatization conditions to provide a hydroisomerized and hydrodearomatized product (218) which may be optionally combined with the iso-paraffinic rich hydrocarbon fraction (228) and/or an external iso-paraffinic rich hydrocarbon fraction not deriving from the hydrodeoxygenated intermediate product (212) and/or at least an amount of the naphtha fraction (222) to provide a further hydroisomerized and hydrodearomatized product (218′).

In a further embodiment at least an amount of said fraction (224″) or (224′″) is directed to contact a material catalytically active in hydroisomerization (HDI) under hydroisomerization conditions and in hydrodearomatization (HDA) under hydrodearomatization conditions to provide a hydroisomerized and hydrodearomatized product (218) which may be optionally combined with the iso-paraffinic rich hydrocarbon fraction (228) and/or an external iso-paraffinic rich hydrocarbon fraction not deriving from the hydrodeoxygenated intermediate product (212) and/or at least an amount of the naphtha fraction (222) to provide a further hydroisomerized and hydrodearomatized product (218′).

The hydroisomerized and hydrodearomatized product (218, 218′) may be suitable for use as jet fuel or as a jet fuel blend component fulfilling standard jet fuel specifications, e.g. ASTM D7566.

In a further embodiment, the hydroisomerized and hydrodearomatized product (218, 218′) comprises less than 1 wt/wt %, 0.5 wt/wt % or 0.1 wt/wt %, calculated by total mass of the aromatic molecules relative to all hydrocarbons in the stream, with the associated benefit of the product of such a process fulfilling jet fuel specification ASTM D7566.

Hydroisomerization has the associated benefit of providing a product complying with the requirements to cold flow properties for jet fuels.

In a further embodiment hydrodearomatization conditions involve a temperature in the interval 200-350° C., a pressure in the interval 20-100 Bar, and a liquid hourly space velocity (LHSV) in the interval 0.5-8 and wherein said material catalytically active in hydrodearomatization comprises an active metal taken from the group comprising platinum, palladium, nickel, cobalt, tungsten and molybdenum, preferably one or more elemental noble metals such as platinum or palladium and a refractory support, preferably amorphous silica-alumina, alumina, silica or titania, or combinations thereof, with the associated benefit of such process conditions being suitable for hydrogenation of aromates. Said material catalytically active in hydrodearomatization under hydrodearomatization conditions may be a material catalytically active in hydrocracking or material catalytically active hydroisomerization operating at moderate temperatures favoring hydrodearomatization. Hydrodearomatization conditions preferably involve at least 50% or 80% conversion of aromatics.

In a further embodiment a hydrogen rich stream comprising at least 90 vol/vol % hydrogen is directed to contact the material catalytically active in hydrodearomatization, with the associated benefit of directing high purity hydrogen required by the overall process to the hydrodearomatization step contributing to shifting the equilibrium away from aromatics.

In a further embodiment hydroisomerization conditions involves a temperature in the interval 250-350° C., a pressure in the interval 30-150 Bar, and a liquid hourly space velocity (LHSV) in the interval 0.5-8 and wherein the material catalytically active in hydroisomerization comprises an active metal taken from the group comprising platinum, palladium, nickel, cobalt, tungsten and molybdenum, preferably one or more elemental noble metals such as platinum or palladium, an acidic support preferably a molecular sieve, more preferably having a topology taken from the group comprising MOR, FER, MRE, MWW, AEL, TON and MTT and an amorphous refractory support comprising one or more oxides taken from the group comprising alumina, silica and titania, with the associated benefit of such conditions and materials being a cost effective and selective process for adjusting the cold flow properties of product.

In a further embodiment the treated product (218, 218′) is directed to a gas/liquid separator to provide a gaseous fraction and a treated intermediate jet product which is directed to a further means of separation, to provide said hydrocarbon fraction suitable for use as a jet fuel and a treated product off gas, with the associated benefit of such a stabilization step providing a jet fuel product in compliance with flash point requirement of jet fuel.

The present invention also refers to the co-production of a n-paraffinic hydrocarbon fraction (229) and jet fuel or a jet fuel blend component from an oxygenate feedstock (202) fulfilling standard jet fuel specifications, e.g. ASTM D7566, with the associated benefit of avoiding hydroisomerization and/or hydrodearomatization.

In a particular embodiment, at least an amount of the naphtha fraction (222) and at least an amount of the iso-paraffinic rich hydrocarbon fraction (228) are combined and advantageously the resulting product is suitable, without being hydroisomerized and/or hydrodearomatized, for use as jet fuel or as a jet fuel blend component fulfilling standard jet fuel specifications, e.g. ASTM D7566.

In a particular embodiment, at least two fractions selected from at least an amount of the fraction (224′″), at least an amount of the naphtha fraction (222) and at least an amount of the iso-paraffinic rich hydrocarbon fraction (228) are combined and advantageously the resulting product is suitable, without being hydroisomerized and/or hydrodearomatized, for use as jet fuel or as a jet fuel blend component fulfilling standard jet fuel specifications, e.g. ASTM D7566.

In a further embodiment the product resulting from the combination of at least an amount of the naphtha fraction (222) and at least an amount of the iso-paraffinic rich hydrocarbon fraction (228) or from the combination of at least two fractions selected from at least an amount of the fraction (224′″), at least an amount of the naphtha fraction (222) and at least an amount of the iso-paraffinic rich hydrocarbon fraction (228) is directed to a gas/liquid separator to provide a gaseous fraction and a treated intermediate jet product which is directed to a further means of separation, to provide said hydrocarbon fraction suitable for use as a jet fuel and a treated product off gas, with the associated benefit of such a stabilization step providing a jet fuel product in compliance with flash point requirement of jet fuel.

A further aspect of the present disclosure relates to a process plant for production of a n-paraffinic hydrocarbon fraction (229) from an oxygenate feedstock (202), said process plant comprising a hydrodeoxygenation section (HDO), a hydrocracking section (HDC), a fractionation section (FRAC) and a separator section (N/I SEP), said process plant being configured for
a. directing the feedstock (202) and an amount of a hydrocracked intermediate product (206, 206′) or another quenching product (203) to the hydrodeoxygenation section (HDO) to provide a hydrodeoxygenated intermediate product (212),
b. directing the hydrodeoxygenated intermediate product (212) and optionally an amount of hydrocracked intermediate product (206, 206′) to said fractionation section (FRAC) to provide
   b1. at least two fractions, including a high boiling product fraction (226) and a low boiling product fraction (224), or
   b2. at least three fractions, including a high boiling product fraction (226), an intermediate boiling product fraction (224′″) and a low boiling product fraction (227),
c. directing at least an amount of the high boiling product fraction (226) to the hydrocracking section (HDC) to provide the hydrocracked intermediate product (206), which is either
   c1. directed to the hydrodeoxygenation section (HDO) as defined in step a, or
   c2. directed to the fractionation section (FRAC) as defined in step b, or
   c3. split into the two fractions of hydrocracked intermediate product (206′ and 206″), wherein the hydrocracked intermediate product (206′) is directed to the hydrodeoxygenation section (HDO) as defined in step a and the hydrocracked intermediate product (206′″) is directed to the fractionation section (FRAC) as defined in step b,
d. if the step b is as defined in b1, optionally splitting the low boiling product fraction (224) in at least two fractions (224′ and 224″), and
e. directing the fraction (224), (224′), or (227) to the separator section (N/I SEP) to provide the n-paraffinic rich hydrocarbon fraction of a defined carbon range (229) and an iso-paraffinic rich hydrocarbon fraction (228).

This process plant has the associated benefit of being suited for carrying out the disclosed process for cost effective and selective production of n-paraffins and, if desired, of jet fuel or a jet fuel blend component.

In certain embodiments, b1 and b2 further include a naphtha fraction (222). In certain embodiments, b1 and b2 further include a naphtha fraction (222) and a light overhead fraction (220)

The processes described in the present disclosure receives an oxygenate feedstock (e.g. a feedstock consisting of or comprising a renewable feedstock) which comprises one or more oxygenates taken from the group consisting of triglycerides, fatty acids, resin acids, ketones, aldehydes, alcohols, phenols and aromatic carboxylic acids where said oxygenates originate from one or more of a biological source, a gasification process, a pyrolysis process, Fischer-Tropsch synthesis, methanol based synthesis or a further synthesis process, especially obtained from a raw material of renewable origin, such as originating from plants, algae, animals, fish, vegetable oil refining, domestic waste, used cooking oil, plastic waste, rubber waste or industrial organic waste like tall oil or black liquor. Some of these feedstocks may contain aromatics; especially products derived by pyrolysis or other processes from e.g. lignin and wood or waste products from e.g. frying oil. Depending on source, the oxygenate feedstock may comprise from 1 wt/wt % to 40 wt/wt %. Biological sources will typically comprise around 10 wt/wt %, and derivation products from 1 wt/wt % to 20 wt/wt % or even 40 wt/wt %.

For the conversion of renewable feedstocks and/or oxygenate feedstocks into hydrocarbon transportation fuels, the feedstocks are together with hydrogen directed to contact a material catalytically active in hydrotreatment, especially hydrodeoxygenation. Especially at elevated temperatures the catalytic hydrodeoxygenation process may have side reactions forming a heavy product e.g. from olefinic molecules in the feedstock. To moderate the release of heat, a liquid hydrocarbon may be added, e.g. a liquid recycle stream or an external diluent feed (quenching product (203)). If the process is designed for co-processing of fossil feedstock and renewable feedstock, it is convenient to use the fossil feedstock as diluent or quenching product, since less heat is released during processing of fossil feedstock, as fewer heteroatoms are released and less olefins are saturated. In addition to moderating the temperature, the recycle or diluent also has the effect of reducing the potential of olefinic material to polymerize, which will form an undesired heavy fraction in the product. The resulting product stream will be a hydrodeoxygenated intermediate product stream comprising hydrocarbons, typically n-paraffins, and sour gases such as CO, CO₂, H₂O, H₂S, NH₃ as well as light hydrocarbons, especially C3 and methane. Especially at elevated temperatures the catalytic hydrodeoxygenation process may result in side reactions forming aromatics. If the feedstocks comprises nitrogen, ammonia may be formed, which can have an effect of deactivating the catalytically active material, thus requiring such elevated temperatures, with consequential formation of aromatics, in amounts above the limit of ASTM D7566 defining jet fuel specification.

The material catalytically active in hydrodeoxygenation typically comprises an active metal (one or more sulfided base metals such as nickel, cobalt, tungsten or molybdenum, but possibly also elemental noble metals such as platinum and/or palladium) and a refractory support (such as alumina, silica or titania or combinations thereof).

Hydrodeoxygenation involves directing the feedstock to contact a catalytically active material typically comprising one or more sulfided base metals such as nickel, cobalt, tungsten or molybdenum, but possibly also elemental noble metals such as platinum and/or palladium, supported on a carrier comprising one or more refractory oxides, typically alumina, but possibly silica or titania. The support is typically amorphous. The catalytically active material may comprise further components, such as boron or phosphorous. The conditions are typically a temperature in the interval 250-400° C. (e.g. 350-390° C. or 350-375° C.), a pressure in the interval 30-150 Bar (e.g. 50-100 or 50-75 Bar), and a liquid hourly space velocity (LHSV) in the interval 0.1-2.2 (e.g. 1-2 or 1.5-2). Hydrodeoxygenation is typically exothermal, and with the presence of a high amount of oxygen, the process may involve intermediate cooling e.g. by quenching with cold hydrogen, feed or product. The feedstock may preferably contain an amount of sulfur to ensure sulfidation of the metals, in order to maintain their activity. If the gas phase comprises less than 10, 50 or 100 ppmᵥ sulfur, a sulfide donor, such as dimethyldisulfide (DMDS) may be added to the feed.

The hydrodeoxygenated intermediate product will mainly be of same structure as the carbon skeleton of the feedstock oxygenates, or if the feedstock comprises triglycerides, n-paraffins, but possibly of a shorter length than the fatty acids. Typically, the hydrodeoxygenated intermediate product has a boiling point range (250° C. to 320° C.) and a freezing point (0° C. to 30° C.) unsuited for use as jet fuel. Some heavy components and aromatics may also be formed in the hydrodeoxygenation step if the unsaturated fatty acids polymerizes and form aromatic structures even for an oxygenate feedstock comprising less than 1% aromatics.

For the hydrodeoxygenated intermediate product stream to be used as a kerosene fraction for n-paraffin recovery (and, if convenient, jet fuel production), the boiling point range must be adjusted. The boiling point is adjusted by hydrocracking of long paraffins to shorter paraffins, by directing the hydrodeoxygenated intermediate product to contact a material catalytically active in hydrocracking.

The material catalytically active in hydrocracking is of a nature similar to that of the material catalytically active in hydroisomerization, and it typically comprises an active metal (either elemental noble metals such as platinum and/or palladium or sulfided base metals such as nickel, cobalt, tungsten and/or molybdenum), an acidic support (typically a molecular sieve showing high cracking activity, and having a topology such as MFI, BEA and FAU, but amorphous acidic oxides such as silica-alumina may also be used) and a refractory support (such as alumina, silica or titania, or combinations thereof). The difference to a material catalytically active in hydroisomerization is typically the nature of the acidic support, which may be of a different structure (even amorphous silica-alumina) or have a different acidity e.g. due to silica:alumina ratio. The catalytically active material may comprise further components, such as boron or phosphorous. Preferred hydrocracking catalysts comprise molecular sieves such as ZSM-5, zeolite Y or beta zeolite.

Hydrocracking involves directing the hydrocarbons to contact a material catalytically active in hydrocracking. The conditions are typically a temperature in the interval 250-410° C. (e.g. 350-405° C.), a pressure in the interval 30-150 Bar (e.g. 50-100 or 50-75 Bar), and a liquid hourly space velocity (LHSV) in the interval 0.5-4 (e.g. 0.75-2). As hydrocracking is exothermal, the process may involve intermediate cooling e.g. by quenching with cold hydrogen, feed or product. When the active metal on the material catalytically active in hydroisomerization is a noble metal, the hydrodeoxygenated feedstock is typically purified by gas/liquid separation to reduce the content of potential catalyst poisons to low levels such as levels of sulfur, nitrogen and carbon oxides to below 1-10 ppmₘₒₗₐᵣ. When the active metal is a base metal the gas phase of the hydrocarbons preferably contains at least 50 ppmᵥ sulfur.

For the recovery of n-paraffins, the fraction (224), (224′) or (227) is directed to the separator section (N/I SEP) wherein separation may take place according to techniques that are well-known in the art. For instance, straight paraffins may be separated from a mixture mainly consisting of straight and branched paraffins by selective adsorption of the straight paraffins on a molecular sieve, followed by desorption of the straight paraffins from the molecular sieve with the aid of hydrogen.

Hydrodeoxygenation of unsaturated fatty acids and hydrocracking may also produce aromatics as a side reaction, especially if the temperature and/or the conversion is high. Therefore, a low conversion during hydrocracking has typically been desired, hindering full conversion to a kerosene fraction. One consideration in increasing conversion has been to recycle hydrocracked intermediate product for additional contact with the material catalytically active in hydrocracking, but even this may produce an extensive amount of aromatics.

To comply with the specifications of the jet fuel a low content of aromatics is required. Therefore, for the production of jet fuel, downstream the fractionation section it may be further necessary to direct the jet range intermediate product to contact a material catalytically active in hydrodearomatization, which is surprising, as the renewable feedstocks contain no or little aromatics.

In some instances hydrodearomatization may be satisfactorily carried out in the presence of the material catalytically active in hydroisomerization, but it may also be necessary to have a separate reactor or reactor bed with material catalytically active in hydrodearomatization.

The material catalytically active in hydrodearomatization typically comprises an active metal (typically elemental noble metals such as platinum and/or palladium but possibly also sulfided base metals such as nickel, cobalt, tungsten and/or molybdenum) and a refractory support (such as amorphous silica-alumina, alumina, silica or titania, or combinations thereof). Hydrodearomatization is equilibrium controlled, with high temperatures favoring aromatics, noble metals are preferred as the active metal, since they are active at lower temperatures, compared to base metals.

Hydrodearomatization involves directing an intermediate product to contact a material catalytically active in hydrodearomatization. As the equilibrium between aromatics and saturation molecules shifts towards aromatics at elevated temperatures, it is preferred that the temperature is moderate. The conditions are typically a temperature in the interval 200-350° C., a pressure in the interval 30-150 Bar, and a liquid hourly space velocity (LHSV) in the interval 0.5-8. As the preferred active metal on the material catalytically active in hydrodearomatization is a noble metal, the hydrocracked intermediate product is typically purified by gas/liquid separation to reduce the content of sulfur to below 1-10 ppm.

This necessity to combine 2, 3 or 4 catalytically active materials for conversion of reneweble feedstocks into linear paraffins and jet fuel naturally complicates the process layout, and the sequence of the materials must be considered carefully. In addition, recycle may be used for three different purposes; gas recycle for efficient use of hydrogen, liquid recycle around the material catalytically active in hydrocracking to maximize the yield of the kerosene fraction and liquid recycle around the material catalytically active in hydrodeoxygenation to limit the temperature increase due to exothermal hydrodeoxygenation reactions.

According to the present disclosure the boiling point of the product is adjusted by hydrocracking in a so-called reverse staging layout. Here the feedstock is combined with a hydrocracked hydrocarbon or another quenching product and directed to the hydrodeoxygenation reactor. The hydrodeoxygenated product stream is split according to boiling point, and at least an amount of the product boiling above the jet range is recycled to a hydrocracking reactor upstream the hydrodeoxygenation reactor. The recycle ratio may be maximized to ensure full conversion to product boiling in the jet range, or a lower recycle ratio may be chosen, while purging an amount of product boiling above the jet range, e.g. for use as diesel.

The hydrodearomatization will typically require sweet conditions, as the catalyst typically comprises a noble metal, which operates at lower temperatures, thus employing the fact that the equilibrium of the hydrodearomatization reaction is shifted away from aromatics at low temperatures. Therefore, a separation of gases may be carried out prior to hydrodearomatization, and optionally also a separation of intermediate hydrocracked product according to boiling point, such that only intermediate hydrocracked product boiling in the kerosene range contacts the material catalytically active in hydrodearomatization.

For the hydrodeoxygenated intermediate product to be used as a fuel in practice, the freezing point must be adjusted. The freezing point is adjusted by reduction of the n-paraffins content or isomerization of n-paraffins to i-paraffins, by directing a jet range intermediate product to contact a material catalytically active in hydroisomerization.

Hydroisomerization may be carried out in connection with hydrodearomatization. The material catalytically active in hydroisomerization may be positioned either upstream or downstream the material catalytically active in hydrodearomatization.

The material catalytically active in hydroisomerization typically comprises an active metal (either elemental noble metals such as platinum and/or palladium or sulfided base metals such as nickel, cobalt, tungsten and/or molybdenum), an acidic support (typically a molecular sieve showing high shape selectivity, and having a topology such as MOR, FER, MRE, MWW, AEL, TON and MTT) and a typically amorphous refractory support (such as alumina, silica or titania, or combinations thereof). The catalytically active material may comprise further components, such as boron or phosphorous. Preferred hydroisomerization catalysts comprise molecular sieves such as EU-2, ZSM-48, beta zeolite and combined beta zeolite and zeolite Y.

Hydroisomerization involves directing the intermediate hydrodeoxygenated feedstock to contact a material catalytically active in hydroisomerization. The conditions are typically a temperature in the interval 250-350° C., a pressure in the interval 30-150 Bar, and a liquid hourly space velocity (LHSV) in the interval 0.5-8. Hydroisomerization is substantially thermally neutral and consumes only hydrogen in hydrocracking side reactions so only a moderate amount of hydrogen is added in the hydroisomerization section. When the active metal on the material catalytically active in hydroisomerization is a noble metal, the hydrodeoxygenated feedstock is typically purified by gas/liquid separation to reduce the content of potential catalyst poisons to low levels such as levels of sulfur, nitrogen and carbon oxides to below 1-10 ppmₘₒₗₐᵣ. When the active metal is a base metal the gas phase of the intermediate hydrodeoxygenated feedstock preferably contains at least 50 ppmᵥ sulfur.

Operating the material catalytically active in hydrocracking with recycle allows full conversion at moderate temperatures, thus maintaining a high yield of kerosene and minimized over-cracking to naphtha and lighter. The use of an hydroisomerization catalyst to improve freezing point of the jet fuel, allows increasing the distillation endpoint of the jet fuel while still meeting freezing point requirement. Finally, since the stage of hydrodearomatization will saturate aromatics, it is not required for the initial stages (hydrodeoxigenation, hydrocracking) to meet any aromatics requirements, which allows to treat initially heavier and/or more aromatic, naphthenic or unsaturated feedstocks as well as feedstocks such as used cooking oil, pyrolysis products or tall oil pitch, which are known to produce aromatics in small amounts in typical hydroprocessing conditions, since these aromatics will be saturated later on in the HDA stage.

One embodiment according to the present disclosure corresponds to a process in which a stream comprising oxygenates and hydrocracked recycled hydrocarbons, and also comprising an amount of sulfur is directed to a hydrodeoxygenation reactor containing a catalytically active material comprising one or more base metals and a refractory support, with low acidity. Such a material is active in hydrodeoxygenation and other hydrotreatment reactions removing heteroatoms and double bonds. An amount of sulfide must be present in the feed stream to the hydrodeoxygenation reactor, either as part of the hydrocracked recycled hydrocarbons, or as added sulfide to the feed stream to the hydrodeoxygenation reactor. The hydrocracked recycled hydrocarbons contribute as a heat sink, absorbing the released heat of reaction from the hydrodeoxygenation, thus maintaining a moderate temperature in the hydrodeoxygenation reactor. This step provides a stream comprising a high amount of saturated linear alkanes, in combination with an amount of water, hydrogen sulfide and ammonia.

The hydrotreated stream is directed to a fractionator (after appropriate removal of the gas phase in a separator train), and at least a gas fraction, an intermediate fraction and a bottoms fraction of the hydrotreated stream are withdrawn. All streams out of the fractionator have a very low level of water, hydrogen sulfide and ammonia. The bottoms fraction will be too heavy for being used as jet product, and is recycled.

The bottoms fraction of the hydrotreated stream is directed to a hydrocracking reactor containing a catalytically active material comprising either one or more base metals or one or more noble metals and a refractory support with high acidity. Such a material is active in hydrocracking, and this step provides a stream in which higher boiling hydrocarbons are converted to lower boiling hydrocarbons.

For reasons of cost, a base metal material may be preferred, and in this case addition of an amount of sulfur, e.g. as DMDS is required at the inlet of the hydrocracking reactor. It may alternatively be preferred to operate with a more expensive and more selective noble metal material; in this case sulfur addition is not required. The severity of the hydrocracking process will define the boiling point characteristics of the product, and it will typically be operated with full conversion of the fraction boiling above the diesel range. If hydrocracking severity is selected for full conversion of the fraction boiling above the jet range the yield loss to gases and naphtha will typically be higher.

If the material catalytically active in hydrocracking comprises noble metals it is necessary to add sulfide, in the form of hydrogen sulfide or di methyl di sulfide (DMDS) prior to the hydrodeoxygenation reactor.

The intermediate hydrotreated fraction comprises a mixture of n- and iso-paraffins which may be separated in the separator section.

The intermediate hydrotreated fraction has a boiling range which is suitable for use as jet fuel, but the content of aromatics and the freezing point are not within specification. Therefore, this fraction is directed to an hydroisomerization reactor containing a material catalytically active in hydroisomerization and a material catalytically active in hydrodearomatization. Both materials are based on a noble metal catalyst, such as platinum, palladium or a combination, in combination with an acidic support. For hydroisomerization the acidic support is preferably shape selective, e.g. a zeolite, to provide a selective isomerization, rearranging linear alkanes to branched alkanes, with minimal production of lighter hydrocarbons. For hydrodearomatization, an acidic support also contribute to the reaction, and in addition as the activity of noble metals is higher than that of base metals, the reaction will take place at lower temperatures. As the equilibrium between aromatic and non-aromatic compounds is shifted away from aromatics at low temperatures, noble metals provide the benefit that the lower temperature matches the equilibrium. Hydrodearomatization may even take place on the material catalytically active in hydroisomerization, which often will have some hydrodearomatization activity. An amount of hydrocracking may occur in the isomerization reactor, and therefore it may be preferred that the hydrocracked stream is slightly heavier than jet specifications.

The layout therefore provides a full conversion of feedstock to jet range or lighter product, as all heavy product is recycled and hydrocracked. The jet range yield is higher than a layout where all hydrocarbons are hydrocracked, since the jet range fraction of the hydrodeoxygenated stream is not recycled to the hydrocracker, but only the bottom fraction from the fractionator.

Furthermore the adjustment of freezing point is made selectively by lowering the n-paraffin content as well as by hydroisomerization on a noble metal catalyst, independently of hydrocracking conditions, and finally hydrodearomatization may be efficiently carried out at moderate temperatures in the same reactor and possibly even the same catalytically active material as hydroisomerization.

As previously noted, in certain instances of the invention, there is no need to carry out hydroisomerization and/or hydrodearomatization for jet fuel production. In this regard, the combination of either at least an amount of the naphtha fraction (222) and at least an amount of the iso-paraffinic rich hydrocarbon fraction (228) or the combination of at least two fractions selected from at least an amount of the fraction (224′″), at least an amount of the naphtha fraction (222) and at least an amount of the iso-paraffinic rich hydrocarbon fraction (228) may result in a product with an adequate freezing point for use as jet fuel or as a jet fuel blend component fulfilling standard jet fuel specifications, e.g. ASTM D7566.

Should it be desired to produce diesel and not jet fuel, hydrocracking is not desired. In this case, it may be preferred to either by-pass the hydrocracking reactor or alternatively cool the product prior to this reactor, such that it is inactive. The process plant may be configured for allowing such a configuration with short notice, e.g. by setting up appropriate equipment and control in the control room.

The n-paraffinic hydrocarbon fraction (229) may be used for instance for producing a linear alkylbenzene product in a process comprising:
i. dehydrogenating at least an amount of the n-paraffinic hydrocarbon fraction (229) to provide a linear mono-olefin hydrocarbon intermediate product; and
ii. alkylating the linear mono-olefin hydrocarbon intermediate product with benzene to provide the linear alkylbenzene product.

### FIGURES

FIGS. 1-10 show exemplary embodiments of different process schemes according to the present disclosure.

FIG. 1 is a figure showing a process layout for producing a n-paraffinic hydrocarbon fraction (229) from an oxygenate feedstock (202) according to the present invention, omitting supply of gaseous streams and details of separation for simplicity. A renewable feedstock (202) is combined with a hydrocracked intermediate product (206, 206′) or another quenching product (203) and directed as a hydrodeoxygenation feed stream (204) together with an amount of a hydrogen rich stream (not shown) to a hydrodeoxygenation section (HDO) where it contacts a material catalytically active in hydrodeoxygenation under hydrodeoxygenation conditions. This provides a hydrodeoxygenated intermediate product (212). The hydrodeoxygenated intermediate product (212), optionally combined with an amount of hydrocracked intermediate product (206, 206″), is directed to a fractionation section (FRAC) shown for simplicity as a single unit, separating the hydrodeoxygenated intermediate product in a light overhead stream (220), a naphtha stream (222), a hydrodeoxygenated intermediate jet product (224) and a high boiling product fraction (226).

The high boiling product fraction (226) is directed as a recycle stream to a hydrocracking section (HDC) operating under hydrocracking conditions, providing a hydrocracked intermediate product (206), which, as mentioned, may be combined with the renewable feed stock (202) or with the hydrodeoxygenated intermediate product (212) or both. The hydrodeoxygenated intermediate jet product (224) is directed to the separator section to provide the n-paraffinic rich hydrocarbon fraction of a defined carbon range (229) and an iso-paraffinic rich hydrocarbon fraction (228).

FIG. 2 is a figure showing the process layout for producing a n-paraffinic hydrocarbon fraction (229) from an oxygenate feedstock (202) of FIG. 1 and further including a post treat section (PT). In this case, the hydrodeoxygenated intermediate jet product (224) is split into two fractions (224′ and 224″), wherein the fraction (224′) is directed to the separator section to provide the n-paraffinic rich hydrocarbon fraction of a defined carbon range (229) and an iso-paraffinic rich hydrocarbon fraction (228). The iso-paraffinic rich hydrocarbon fraction (228) is combined with the fraction (224″) to form a combined fraction (230) which is directed as feed to the post treat section (PT), where it contacts a material catalytically active in hydroisomerization (ISOM) under hydroisomerization conditions and a material catalytically active in hydrodearomatization (HDA) under hydrodearomatization conditions, providing a treated jet fuel product (218). In other embodiments, the fraction (224″) is not combined with the iso-paraffinic rich hydrocarbon fraction (228) but directly directed to the post treat section (PT).

FIG. 3 is a figure showing the process layout for producing a n-paraffinic hydrocarbon fraction (229) from an oxygenate feedstock (202) according to the present invention similar to FIG. 2 but employing a different PT set-up. In this case, the hydrodeoxygenated intermediate jet product (224) is split into two fractions (224′ and 224″), wherein the fraction (224′) is directed to the separator section to provide the n-paraffinic rich hydrocarbon fraction of a defined carbon range (229) and an iso-paraffinic rich hydrocarbon fraction (228) whereas the fraction (224″) is directed as feed to the post treat section (PT), where it contacts a material catalytically active in hydroisomerization (ISOM) under hydroisomerization conditions and a material catalytically active in hydrodearomatization (HDA) under hydrodearomatization conditions, providing a treated jet fuel product (218). This jet product is combined with the iso-paraffinic rich hydrocarbon fraction (228) to provide a jet fuel product (218′). In other embodiments, the product (218) fulfills standard jet fuel specifications, e.g. ASTM D7566, without being combined with the iso-paraffinic rich hydrocarbon fraction (228).

FIG. 4 is a figure showing a process layout for producing a n-paraffinic hydrocarbon fraction (229) from an oxygenate feedstock (202) according to the present invention, omitting supply of gaseous streams and details of separation for simplicity. A renewable feedstock (202) is combined with a hydrocracked intermediate product (206, 206′) or another quenching product (203) and directed as a hydrodeoxygenation feed stream (204) together with an amount of a hydrogen rich stream (not shown) to a hydrodeoxygenation section (HDO) where it contacts a material catalytically active in hydrodeoxygenation under hydrodeoxygenation conditions. This provides a hydrodeoxygenated intermediate product (212). The hydrodeoxygenated intermediate product (212), optionally combined with an amount of hydrocracked intermediate product (206. 206″), is directed to a fractionation section (FRAC) shown for simplicity as a single unit, separating the hydrodeoxygenated intermediate product in a light overhead stream (220), a naphtha stream (222), a hydrodeoxygenated intermediate jet product (227), a heavier hydrodeoxygenated intermediate jet product (224 —) and a high boiling product fraction (226).

The high boiling product fraction (226) is directed as a recycle stream to a hydrocracking section (HDC) operating under hydrocracking conditions, providing a hydrocracked intermediate product (206), which, as mentioned, may be combined with the renewable feed stock (202) or with the hydrodeoxygenated intermediate product (212) or both. The hydrodeoxygenated intermediate jet product (227) is directed to the separator section to provide the n-paraffinic rich hydrocarbon fraction of a defined carbon range (229) and an iso-paraffinic rich hydrocarbon fraction (228).

FIG. 5 is a figure showing the process layout for producing a n-paraffinic hydrocarbon fraction (229) from an oxygenate feedstock (202) of FIG. 4 and further including a post treat section (PT). In this case, the iso-paraffinic rich hydrocarbon fraction (228) is combined with the fraction (224 —) to form a combined fraction (230) which is directed as feed to the post treat section (PT), where it contacts a material catalytically active in hydroisomerization (HDI) under hydroisomerization conditions and a material catalytically active in hydrodearomatization (HDA) under hydrodearomatization conditions, providing a treated jet fuel product (218). In other embodiments, the fraction (224 —) is not combined with the iso-paraffinic rich hydrocarbon fraction (228) but directly directed to the post treat section (PT).

FIG. 6 is a figure showing a process layout for producing a n-paraffinic hydrocarbon fraction (229) from an oxygenate feedstock (202) according to the present invention similar to FIG. 5 but employing a different PT set-up. In this case, the iso-paraffinic rich hydrocarbon fraction (228) is not subjected to hydroisomerization and hydrodearomatization but combined with the hydroisomerized and hydrodearomatized product (218) to provide a jet fuel product (218′). In other embodiments, the product (218) fulfills standard jet fuel specifications, e.g. ASTM D7566, without being combined with the iso-paraffinic rich hydrocarbon fraction (228).

FIG. 7 is a figure showing a process layout for producing a n-paraffinic hydrocarbon fraction (229) from an oxygenate feedstock (202) according to the present invention similar to FIG. 2 but employing a different PT set-up. In this case, the iso-paraffinic rich hydrocarbon fraction (228) is combined with the fraction (224″) as well as with the naphtha fraction (222) to form a combined fraction (230) which is directed as feed to the post treat section (PT), where it contacts a material catalytically active in hydroisomerization (ISOM) under hydroisomerization conditions and a material catalytically active in hydrodearomatization (HDA) under hydrodearomatization conditions, providing a treated jet fuel product (218). In other embodiments, the naphtha fraction (222) is not combined with the iso-paraffinic rich hydrocarbon fraction (228) and the fraction (224″) but combined with the treated jet fuel product (218) downstream the post treat section (PT) to provide a jet fuel product (218′).

FIG. 8 is a figure showing a process layout for producing a n-paraffinic hydrocarbon fraction (229) from an oxygenate feedstock (202) according to the present invention similar to FIG. 3 but employing a different PT set-up. In this case, the fraction (224″) is combined with the naphtha fraction (222) and the combined fraction is directed as feed to the post treat section (PT), where it contacts a material catalytically active in hydroisomerization (ISOM) under hydroisomerization conditions and a material catalytically active in hydrodearomatization (HDA) under hydrodearomatization conditions, providing a treated jet fuel product (218). This jet product is combined with the iso-paraffinic rich hydrocarbon fraction (228) to provide a jet fuel product (218′). In other embodiments, the naphtha fraction (222) is not combined with the fraction (224″) but combined with the treated jet fuel product (218) and the iso-paraffinic rich hydrocarbon fraction (228) downstream the post treat section (PT) to provide a jet fuel product (218′).

FIG. 9 is a figure showing a process layout for producing a n-paraffinic hydrocarbon fraction (229) from an oxygenate feedstock (202) according to the present invention similar to FIG. 5 but employing a different PT set-up. In this case, the iso-paraffinic rich hydrocarbon fraction (228) is combined with the fraction (224 —) as well as with the naphtha fraction (222) to form a combined fraction (230) which is directed as feed to the post treat section (PT), where it contacts a material catalytically active in hydroisomerization (HDI) under hydroisomerization conditions and a material catalytically active in hydrodearomatization (HDA) under hydrodearomatization conditions, providing a treated jet fuel product (218). In other embodiments, the naphtha fraction (222) is not combined with the iso-paraffinic rich hydrocarbon fraction (228) and the fraction (224′″) but combined with the treated jet fuel product (218) downstream the post treat section (PT) to provide a jet fuel product (218′).

FIG. 10 is a figure showing a process layout for producing a n-paraffinic hydrocarbon fraction (229) from an oxygenate feedstock (202) according to the present invention similar to FIG. 6 but employing a different PT set-up. In this case, the fraction (224 —) is combined with the naphtha fraction (222) to form a combined fraction which is directed as feed to the post treat section (PT), where it contacts a material catalytically active in hydroisomerization (HDI) under hydroisomerization conditions and a material catalytically active in hydrodearomatization (HDA) under hydrodearomatization conditions, providing a treated jet fuel product (218). This jet product is combined with the iso-paraffinic rich hydrocarbon fraction (228) to provide a jet fuel product (218′). In other embodiments, the naphtha fraction (222) is not combined with the fraction (224′″) but combined with the treated jet fuel product (218) and the iso-paraffinic rich hydrocarbon fraction (228) downstream the post treat section (PT) to provide a jet fuel product (218′).

FIGS. 11-13 show respectively the C6-C9, the C10-C13 and the C14-C21 paraffin content (%), including % of n-paraffins, iso-paraffins and total paraffins, of the hydrodeoxygenated and hydrocracked products obtained under different conditions from Camelina oil in example 1.

FIGS. 14 and 15 show the n vs iso paraffin C6-C21 content (%) and the carbon range distribution of the hydrodeoxygenated and hydrocracked products obtained under different conditions from Camelina oil in example 1.

FIGS. 16-18 show respectively the C6-C9, the C10-C13 and the C14-C21 paraffin content (%), including % of n-paraffins, iso-paraffins and total paraffins, of the hydrodeoxygenated and hydrocracked products obtained under different conditions from Used Cooking Oil (UCO) in example 2.

FIGS. 19 and 20 show the n vs iso paraffin C6-C21 content (%) and the carbon range distribution of the hydrodeoxygenated and hydrocracked products obtained under different conditions from Used Cooking Oil (UCO) in example 2.

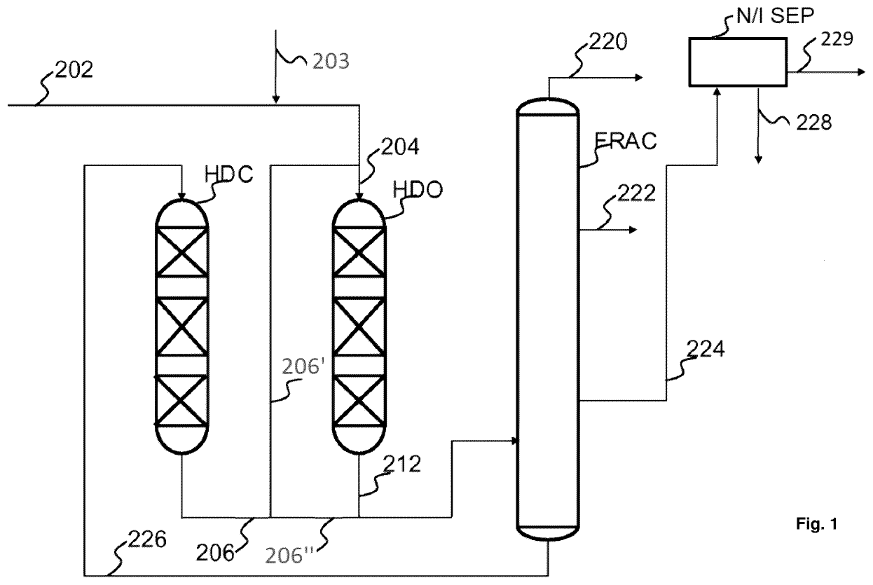

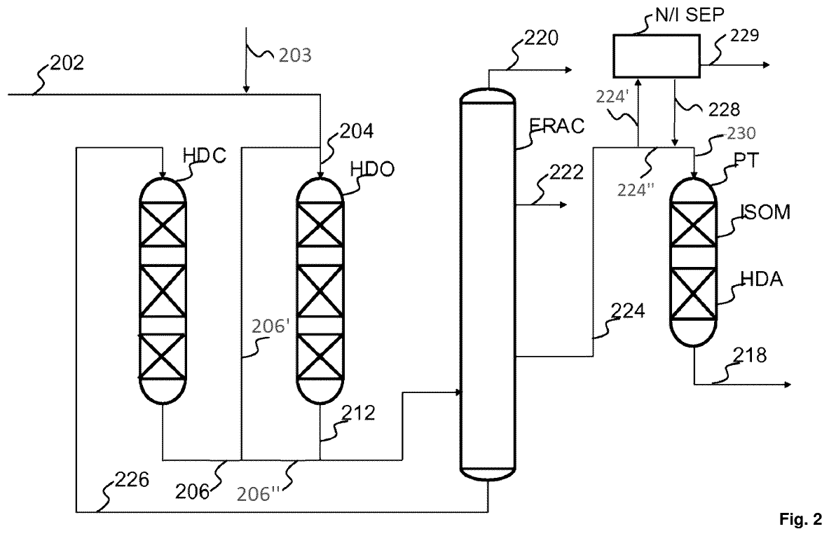

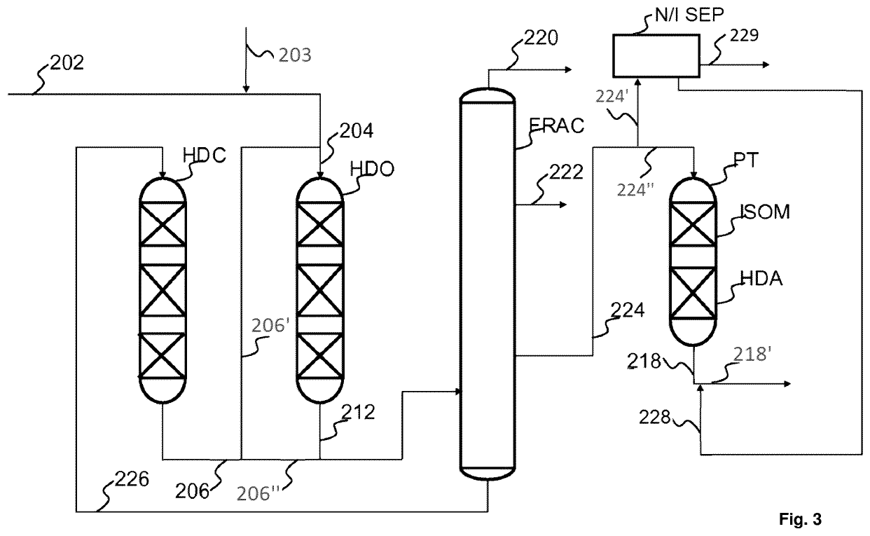

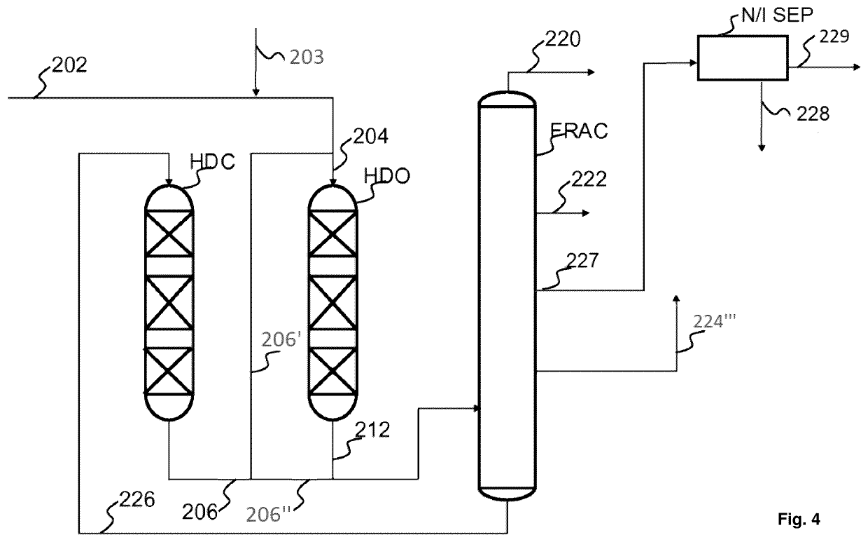

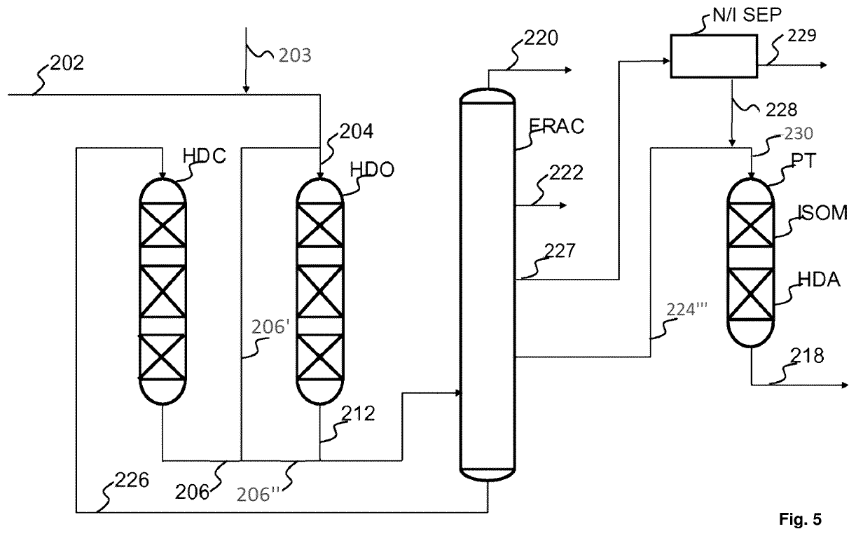

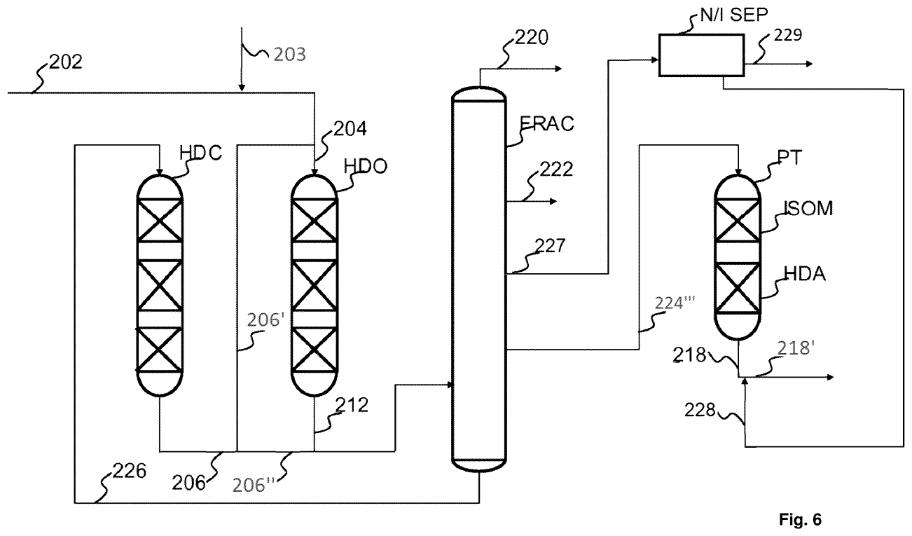

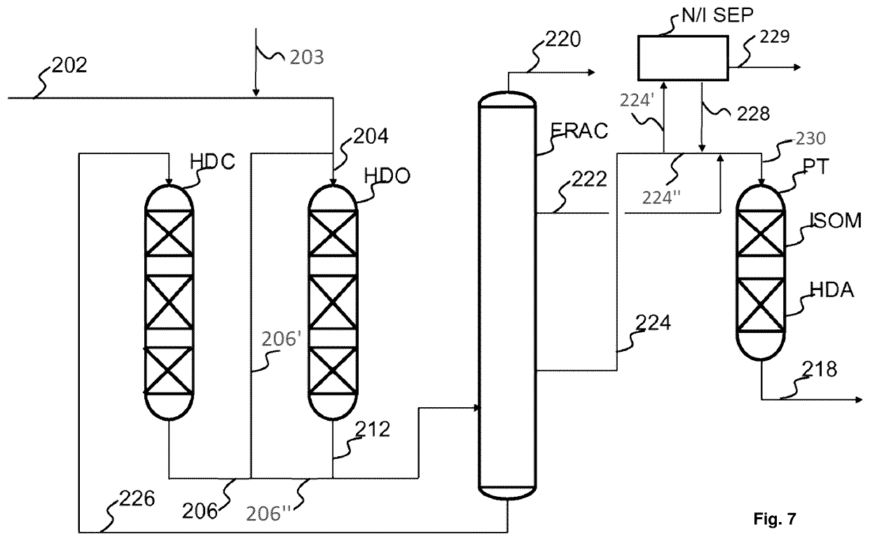

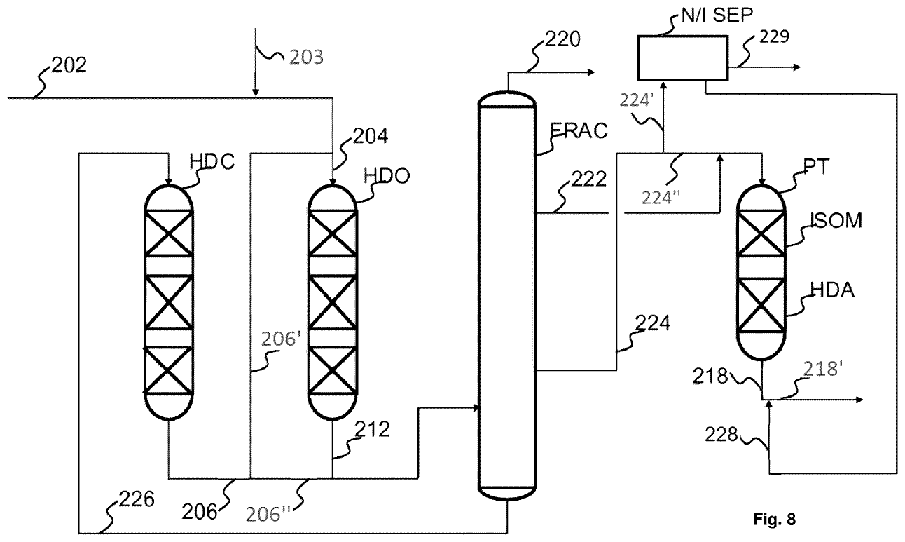

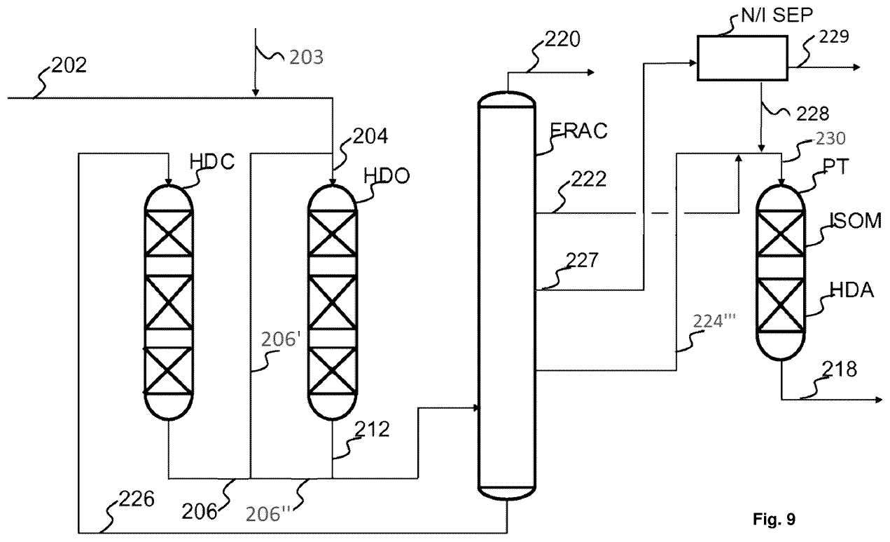

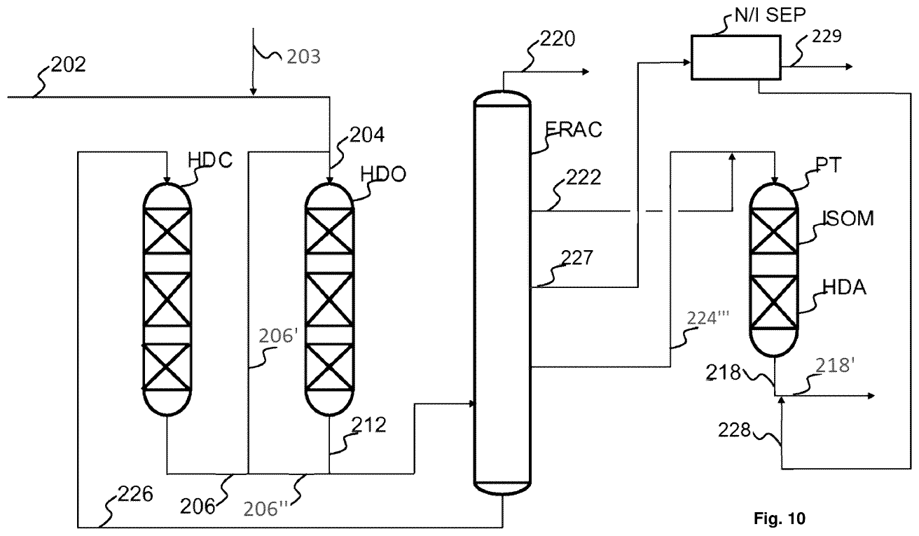

### EXAMPLES

In the following the abbreviation wt shall be used to signify weight.

In the following the phrase Catalyst volume (cc): dil. 50% CSi shall be used to signify Ratio Catalyst to inert (Silicon Carbide) in volume.

In the following the abbreviation T shall be used to signify Temperature.

In the following the abbreviation LHSV (h-1) shall be used to signify Liquid Hourly Space Velocity.

In the following the abbreviation H2/Hc ratio (IH2/I Oil)) shall be used to signify Hydrogen Flow in relation to oil Flow to the reactor (Gas to liquid ratio).

In the following the phrase Oil/diluent ratio (Wt) shall be used to signify Oil Flow in relation to diluent entering to the reactor (Reactant to diluent ratio).

### Example 1—Production of Paraffins from Camelina Oil

Camelina oil was selected as oxygenate feedstock since is a natural oil with heavy paraffins, so different ranges of paraffins can be obtained depending on the process conditions. Camelina oil is not produced from food crops so it is not an edible oil.

In a first step Camelina oil was hydrotreated (i.e. hydrodeoxygenated) under conditions described in table 1 in a laboratory fix bed pilot plant (bench scale).

Hydrodeoxygenation and hydrocracking reactions are highly exothermic. To ensure flow and heat distribution in pilot plats, dilution of catalyst with inert is more than convenient. Test were done diluting the catalyst with an inert (Silicon carbide). Catalyst to SiC ratio was 50:50 in volume

TABLE 1
Hydrodeoxygenation conditions

| | | |
|---|---|---|
| Oil | Cameline | Cameline |
| Catalyst | Alumina with | Alumina with |
| | Co and Mo | Co and Mo |
| Catalyst volume (cc): dil. 50% CSi | 120-130 | 126.8 |
| Pressure (Bar) | 55 | 55 |
| T (° C.) | 357 | 372 |
| LHSV (h−1) | 1.99 | 2.00 |
| H2/Hc ratio (IH2/l Oil) | 340 | 340 |
| Oil/diluent ratio (Wt) | 40/60 | 40/60 |
| diluent | n-tetradecane | n-heptane |

Characterization of the hydrodeoxygenated and hydrocracked products was done using gas chromatography (GC) and gas chromatography coupled to a mass spectrometer (GC-MS).

Conditions Used:
Equipment: HP/Agilent 5890 Serie II
Column: HP-1/HP-5
Length: 30 m, Inner diameter 0.25 mm, Film thickness 0.25 μm
Ramp at &QC/min from 60° C. to 300° C. (final time 10 min)
SCAN mode m/c=50-400 (GC-MS)
Diluent eliminated by calculation.

The Hydrotreated Vegetable Oil or Hydrodeoxygenated Vegetable Oil obtained from Camelina oil (HVO Cam) was then hydrocracked under different conditions described in table 2

TABLE 2
Hydrocracking conditions

| | HyC1 | | HyC2 | | HyC3 | | HyC4 | | | HyC5 | |
|---|---|---|---|---|---|---|---|---|---|---|---|
| Catalyst | Y Zeolite | | Alumina | | Y Zeolite | | Y Zeolite with Ni, | | | Y Zeolite | |
| | with Ni, Mo | | with Ni and | | with Ni and | | Mo and alumina | | | with Ni and | |
| | and alumina | | Mo. | | W and silica | | as binder | | | W and silica | |
| | as binder | | | | as binder | | | | | as binder | |
| Catalyst | — | | 124.4 | | 121.8 | | 124.4 | | | 121.9 | |
| volume (cc) | | | | | | | | | | | |
| Pressure | 55 | | 55 | | 55 | | 55 | | | 55 | |
| (Bar) | | | | | | | | | | | |
| H2/Hc ratio | 1000 | | 1000 | | 1000 | | 1000 | | | 1000 | |
| (I H2/I oil) | | | | | | | | | | | |
| T (° C.) | 395 | 405 | 390 | 400 | 390 | 400 | 350 | 370 | 390 | 360 | 405 |

| | | | | | | | |
|---|---|---|---|---|---|---|---|
| LHSV (h−1) | 0.75 | 1.52 | 1.47 | 1.1 | 1.1 | 1.03 | 1.2 |

| HVO/diluent | 40/60 | 40/60 | 40/60 | 40/60 | 40/60 |
|---|---|---|---|---|---|
| ratio (Wt) | | | | | |
| diluent | n-heptane | n- | n- | n-heptane | n-heptane |

| | |
|---|---|
| tetradecane | tetradecane |

The hydrocracking process was carried out in continuous obtaining product at different temperatures in every experiment.

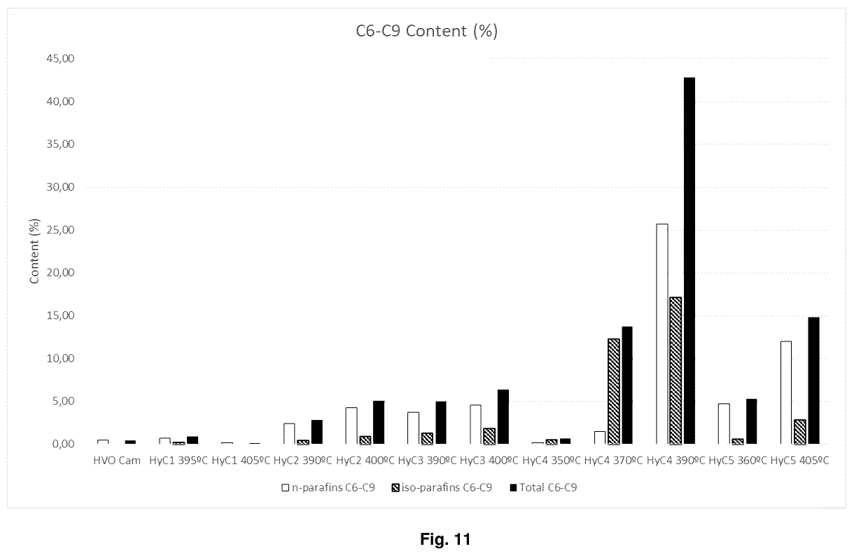

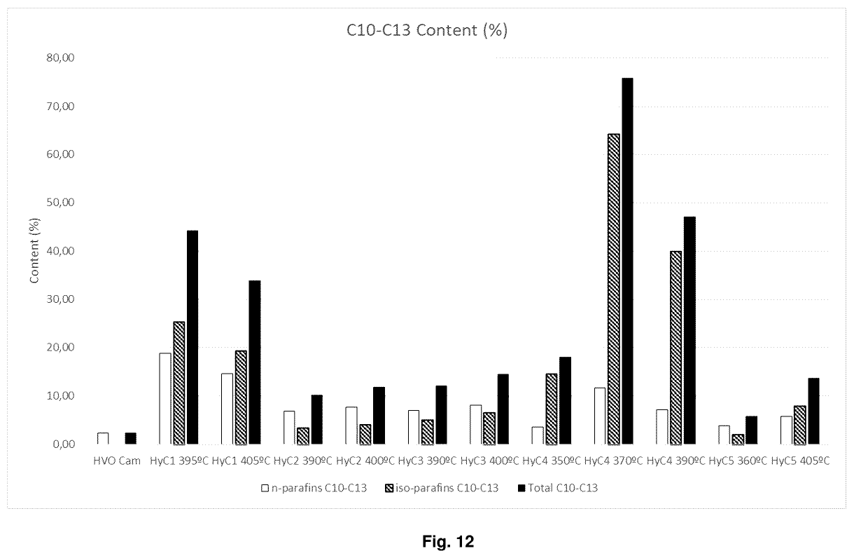

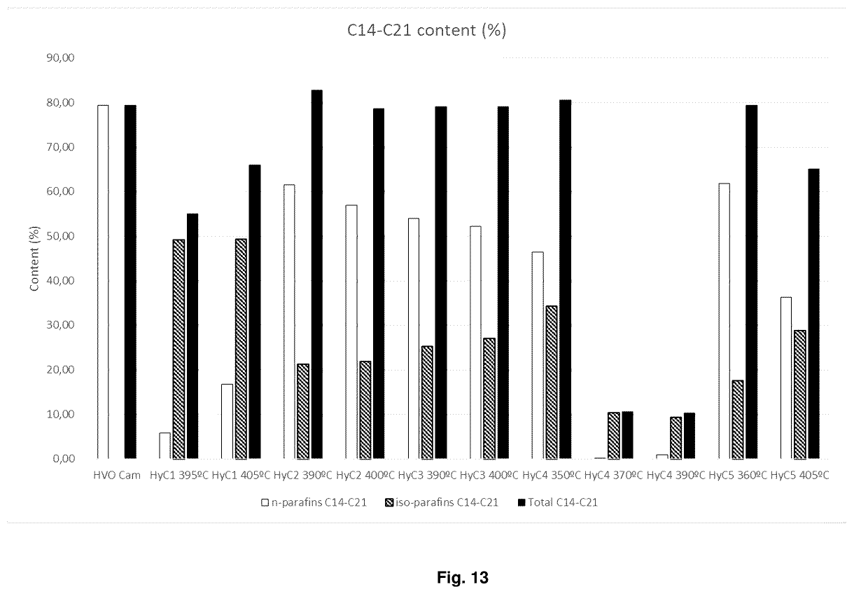

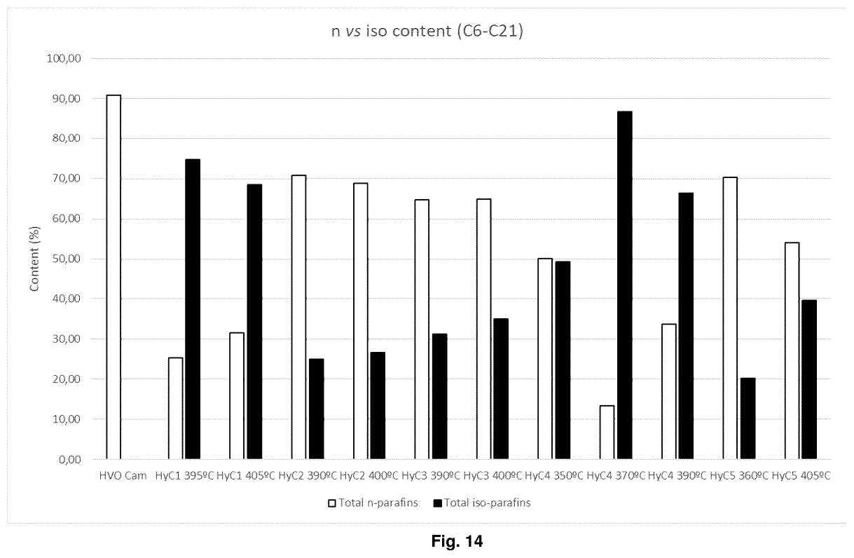

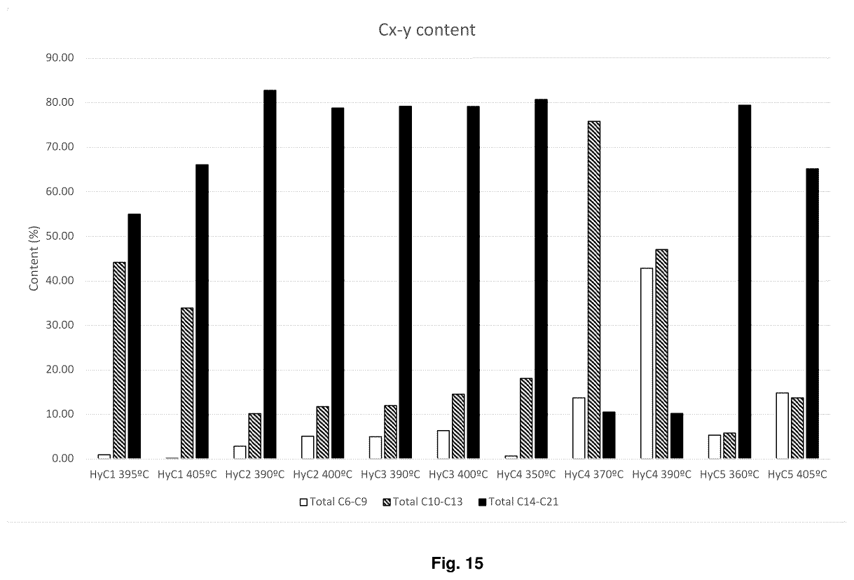

Tables 3 and 4 show how the use of different hydrocracking conditions gave different results in the content of n-paraffins with variations between 13.24% and 82.16%. Something similar occurs with the length of the chains, varying the content of C6-C9 between 0.12% and 42.81% (n-paraffins C6-C9 between 0.12% and 25.70%), the content of C10-C13 between 2.37% and 75.77% (n-paraffins C10-C13 between 2.37% and 18.85%) and the content of C14-C21 between 10.18% and 82.76% (n-paraffins C14-C21 between 0.20% and 79.36%). See FIGS. 11-15.

The results show that, depending on the selected conditions, it is possible to maximize the content of n-paraffins in the desired chain length range.

TABLE 3
Composition of hydrotreated and hydrocracked products.

| | | HyC1 | HyC1 | HyC2 | HyC2 | HyC3 | HyC3 | HyC4 | HyC4 | HyC4 | HyC5 | HyC5 |
|---|---|---|---|---|---|---|---|---|---|---|---|---|
| | HVO Cam | 395° C. | 405° C. | 390° C. | 400° C. | 390° C. | 400° C. | 350° C. | 370° C. | 390° C. | 360° C. | 405° C. |
| Lighter compounds | | | 0.07 | 0.49 | 0.49 | 0.59 | 0.01 | 0.01 | 0.01 | 0.90 | 3.00 | |
| iso C6 | | | | | | | | | | 0.10 | 0.60 | |
| nC6 | | | 0.64 | 1.36 | 1.39 | 1.77 | 0.13 | 0.35 | 13.82 | 1.10 | 3.00 | |
| iso C7 | | | 0.20 | 0.41 | 0.49 | 0.68 | 0.01 | 0.28 | 7.59 | 0.30 | 1.10 | |
| nC7 | 0.00 | | 1.58 | 2.20 | 1.68 | 2.05 | 0.03 | 1.06 | 5.16 | 1.20 | 3.00 | |
| iso C8 | | | 0.24 | 0.35 | 0.60 | 0.86 | 0.47 | 12.00 | 9.52 | 0.20 | 1.10 | 0.18 |
| nC8 | 0.13 | 0.12 | 0.11 | 0.16 | 0.12 | 0.16 | 0.02 | 0.02 | 6.71 | 1.50 | 3.00 | 0.73 |
| iso C9 | | 1.41 | 0.26 | 0.31 | 0.31 | 0.42 | 3.89 | 24.70 | 17.96 | 1.30 | 2.50 | 4.09 |
| nC9 | 0.30 | 3.07 | 2.17 | 2.46 | 2.05 | 2.41 | 1.29 | 4.59 | 3.46 | 1.30 | 1.80 | 4.90 |
| iso C10 | | 6.59 | 0.72 | 0.99 | 1.22 | 1.64 | 3.68 | 14.70 | 7.69 | 0.40 | 2.00 | 8.67 |
| nC10 | 0.41 | 5.82 | 1.75 | 1.97 | 1.66 | 1.99 | 0.95 | 2.92 | 1.36 | 0.90 | 1.10 | 7.29 |
| iso C11 | | 6.44 | 1.20 | 1.43 | 1.44 | 1.81 | 3.52 | 14.04 | 8.35 | 0.10 | 1.90 | 9.43 |
| nC11 | 0.46 | 3.53 | 1.39 | 1.56 | 1.35 | 1.57 | 1.17 | 2.57 | 1.43 | 0.90 | 1.40 | 3.80 |
| iso C12 | | 4.85 | 1.12 | 1.34 | 2.02 | 2.59 | 3.48 | 10.72 | 5.89 | 0.20 | 1.50 | 3.08 |
| nC12 | 0.53 | 2.15 | 1.52 | 1.68 | 1.89 | 2.09 | 0.09 | 1.53 | 0.84 | 0.70 | 1.50 | 2.87 |
| iso C13 | | 7.02 | 4.76 | 5.11 | 7.99 | 8.09 | 2.97 | 6.17 | 4.08 | 0.70 | 1.70 | 10.03 |
| nC13 | 0.97 | 7.05 | 39.75 | 37.85 | 35.63 | 36.85 | 0.81 | 0.03 | 0.18 | 1.80 | 2.00 | 0.39 |
| iso C14 | | 10.10 | 2.17 | 2.61 | 2.67 | 3.09 | 2.66 | 2.15 | 2.15 | 0.20 | 4.30 | 16.46 |
| nC14 | 12.15 | 4.75 | 4.93 | 4.68 | 4.50 | 4.23 | 4.78 | 0.06 | 0.36 | 5.70 | 1.80 | 5.36 |
| iso C15 | | 8.16 | 1.46 | 1.86 | 1.89 | 2.45 | 6.00 | 1.16 | 1.19 | 0.10 | 2.10 | 8.88 |
| nC15 | 5.18 | 0.78 | 1.74 | 1.67 | 1.52 | 1.46 | 2.58 | 0.07 | 0.15 | 2.20 | 3.90 | |
| iso C16 | | 6.34 | 2.36 | 2.80 | 3.46 | 3.06 | 10.21 | 0.67 | 0.90 | 3.00 | 8.60 | 13.84 |
| nC16 | 1.95 | 4.17 | 6.90 | 5.83 | 5.85 | 4.47 | 22.49 | 0.03 | 0.11 | 23.10 | 4.20 | |
| iso C17 | | 17.64 | 3.40 | 3.01 | 2.62 | 3.22 | 6.38 | 0.19 | 0.24 | 2.80 | 3.80 | |
| nC17 | 29.73 | | 3.21 | 2.72 | 2.32 | 1.99 | 7.85 | 0.01 | 0.02 | 7.70 | 3.90 | |
| iso C18 | | | 2.21 | 1.60 | 2.15 | 2.65 | 3.35 | | 0.26 | 1.90 | 5.50 | |
| nC18 | 12.58 | | 3.56 | 2.91 | 2.95 | 2.21 | 5.75 | | 0.01 | 14.10 | 4.00 | |
| iso C19 | | | 0.56 | 0.60 | 0.48 | 0.67 | 0.40 | | 0.49 | 3.20 | 1.80 | |
| nC19 | 11.02 | | 0.53 | 0.51 | 0.48 | 0.39 | 1.71 | | 0.03 | 4.20 | 6.00 | |
| iso C20 | | | 4.31 | 4.18 | 3.90 | 3.75 | 2.23 | | | 5.70 | 1.00 | |
| nC20 | 4.60 | | 0.92 | 0.80 | 0.76 | 0.56 | 0.50 | | 0.01 | 3.00 | 10.50 | |
| iso C21 | | | 0.07 | 0.49 | 0.49 | 0.59 | 0.01 | 0.01 | 0.01 | 0.90 | 3.00 | |
| nC21 | 2.15 | | | | | | | | | 0.10 | 0.60 | |
| nC22 | 8.69 | | | | | | | | | | | |

TABLE 4
Composition of hydrotreated and hydrocracked products.

| | HVO | HyC1 | HyC1 | HyC2 | HyC2 | HyC3 | HyC3 | HyC4 | HyC4 | HyC4 | HyC5 | HyC5 |
|---|---|---|---|---|---|---|---|---|---|---|---|---|
| | Cam | 395° C. | 405° C. | 390° C. | 400° C. | 390° C. | 400° C. | 350° C. | 370° C. | 390° C. | 360° C. | 405° C. |
| Total n-parafins | 24.78 | 82.16 | 25.33 | 31.45 | 70.78 | 68.85 | 64.64 | 64.80 | 50.15 | 13.24 | 33.66 | 70.30 |
| Total iso-parafins | 11.79 | 0.00 | 74.67 | 68.55 | 24.96 | 26.59 | 31.25 | 34.97 | 49.26 | 86.78 | 66.32 | 20.20 |
| n-parafins C6-C9 | 0.02 | 0.43 | 0.73 | 0.12 | 2.40 | 4.20 | 3.68 | 4.57 | 0.19 | 1.44 | 25.70 | 4.70 |
| iso-parafins C6-C9 | 0.12 | 0.00 | 0.18 | 0.00 | 0.44 | 0.88 | 1.30 | 1.78 | 0.48 | 12.28 | 17.11 | 0.60 |
| Total C6-C9 | 0.14 | 0.43 | 0.91 | 0.12 | 2.84 | 5.08 | 4.98 | 6.35 | 0.67 | 13.72 | 42.81 | 5.30 |
| n-parafins C10-C13 | 20.35 | 2.37 | 18.85 | 14.57 | 6.84 | 7.67 | 6.95 | 8.07 | 3.50 | 11.61 | 7.10 | 3.80 |
| iso-parafins C10-C13 | 11.79 | 0.00 | 25.28 | 19.28 | 3.30 | 4.07 | 5.00 | 6.46 | 14.57 | 64.16 | 39.90 | 2.00 |
| Total C10-C13 | 32.14 | 2.37 | 44.13 | 33.85 | 10.14 | 11.74 | 11.95 | 14.53 | 18.08 | 75.77 | 47.00 | 5.80 |
| n-parafins C14-C21 | 4.42 | 79.36 | 5.75 | 16.75 | 61.54 | 56.97 | 54.01 | 52.17 | 46.46 | 0.20 | 0.87 | 61.80 |
| iso-parafins C14-C21 | 0.00 | 0.00 | 49.21 | 49.27 | 21.22 | 21.77 | 25.16 | 26.97 | 34.21 | 10.34 | 9.31 | 17.60 |
| Total C14-C21 | 4.42 | 79.36 | 54.97 | 66.02 | 82.76 | 78.75 | 79.18 | 79.14 | 80.66 | 10.54 | 10.18 | 79.40 |

### Example 2: Production of Paraffins from Used Cooking Oil (UCO)

In this example used cooking oil was used as oxygenate feedstock. This product is a residue from domestic usage and can be consider as a second generation oil.

In a first step used vegetal oil was hydrotreated (i.e. hydrodeoxygenated) under conditions described in table 5 in a fix bed pilot plant (bench scale).

Hydrodeoxygenation and hydrocracking reactions are highly exothermic. To ensure flow and heat distribution in pilot plats, dilution of catalyst with inert is more than convenient. Test were done diluting the catalyst with an inert (Silicon carbide). Catalyst to SiC ratio was 50:50 in volume

TABLE 5
Hydrodeoxygenation conditions

| | |
|---|---|
| Oil | UCO |
| Catalyst | Alumina with Co and Mo |
| Catalyst volume (cc): dil. 50% CSI | 125 |
| Pressure (Bar) | 55 |
| T (° C.) | 366 |
| H2/Hc ratio (L H2/l oil) | 340 |
| LHSV (h−1) | 1.99 |
| Oil/diluent ratio (Wt) | 40/60 |
| diluent | n-heptane |

Characterization of the hydrodeoxygenated and hydrocracked products was done using gas chromatography (GC) and gas chromatography coupled to a mass spectrometer (GC-MS).

Conditions Used:
Equipment: HP/Agilent 5890 Serie II
Column: HP-1/HP-5
Length: 30 m, Inner diameter 0.25 mm, Film thickness 0.25 μm
Ramp at 5° C./min from 60° C. to 300° C. (final time 10 min)
SCAN mode mic-50-400 (GC-MS)
Diluent eliminated by calculation.

The HVO obtained from Used Cooking Oil (HVO UCO) was then hydrocracked under different conditions described in table 6.

TABLE 6
Hydrocracking conditions

| | HyC7 | | | | |
|---|---|---|---|---|---|
| Catalyst | Y Zeolite with Ni, Mo and alumina as binder | | | | |
| Pressure (Bar) | 55 | | | | |
| H2/Hc ratio (L H2/l oil) | 1000 | | | | |
| T (° C.) | 362 | 369 | 376 | 382 | 389 |

| | |
|---|---|
| LHSV (h−1) | 1.0 |
| HVO/diluent ratio (Wt) | 40/60 |
| Diluent | n-heptane |

The hydrocracking process was carried out in continuous obtaining products at different temperatures in every experiment.

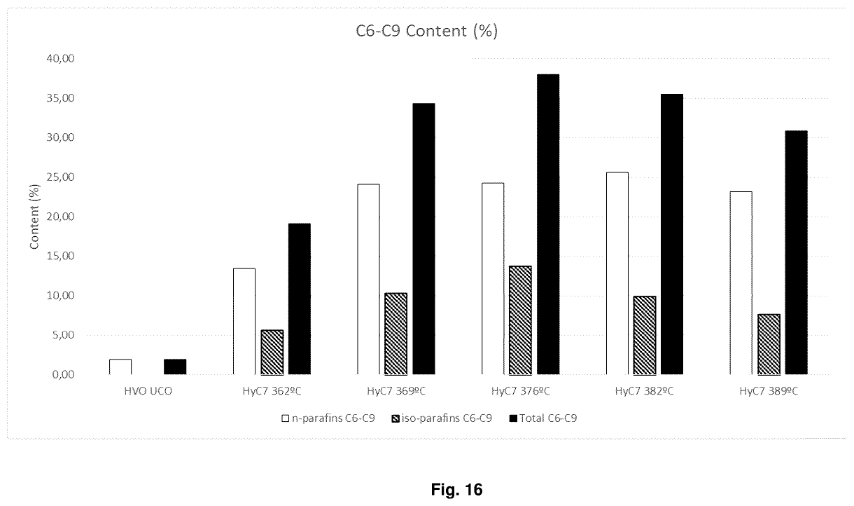

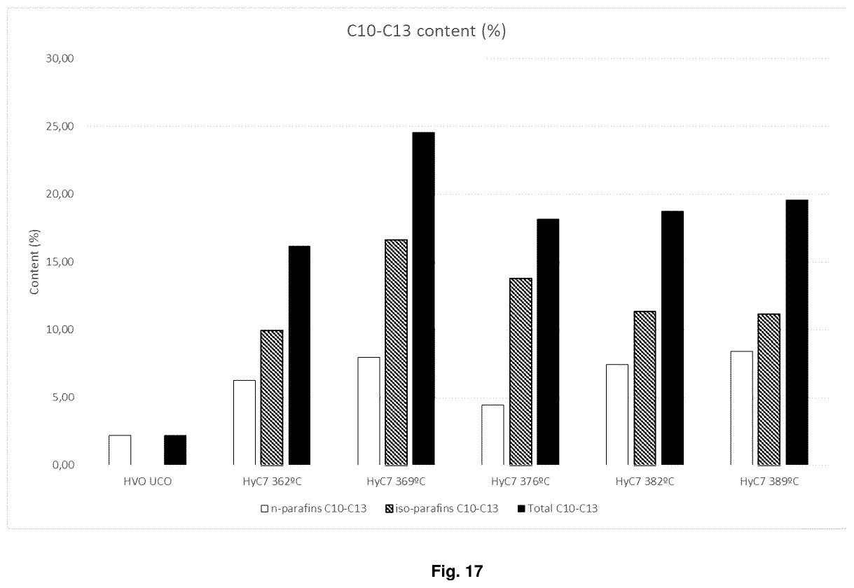

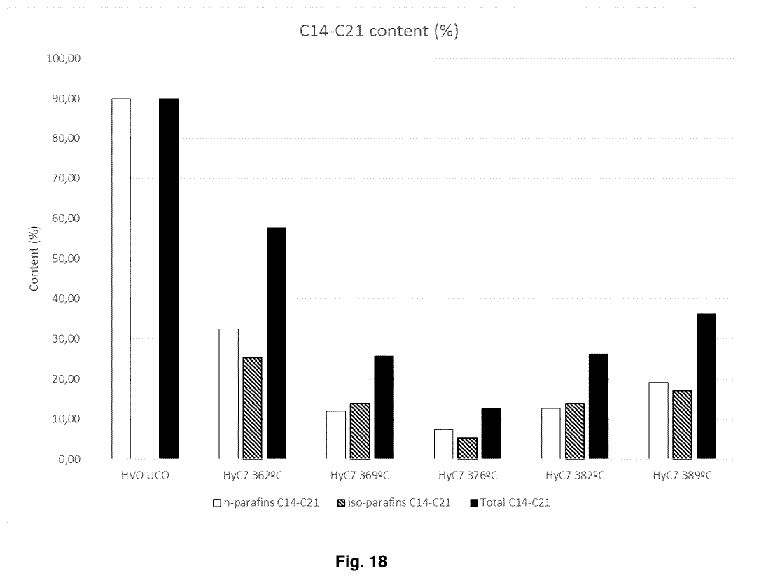

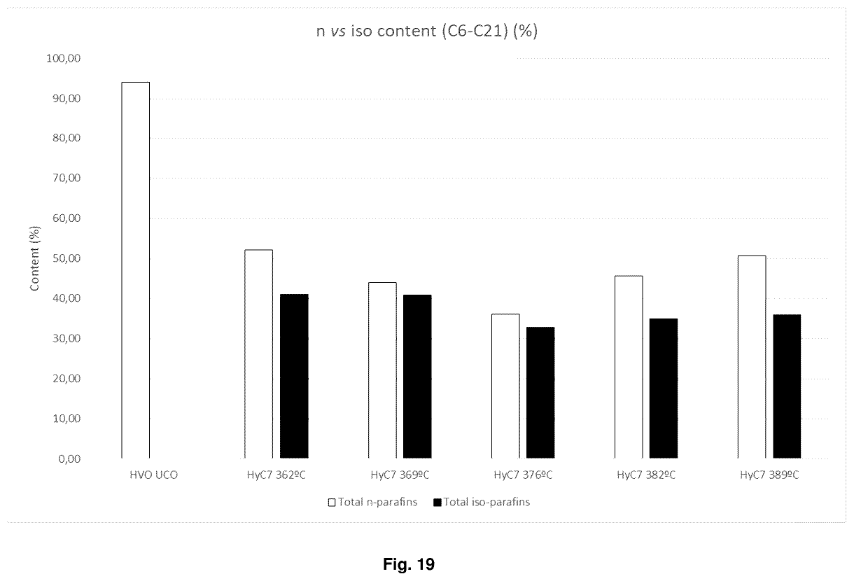

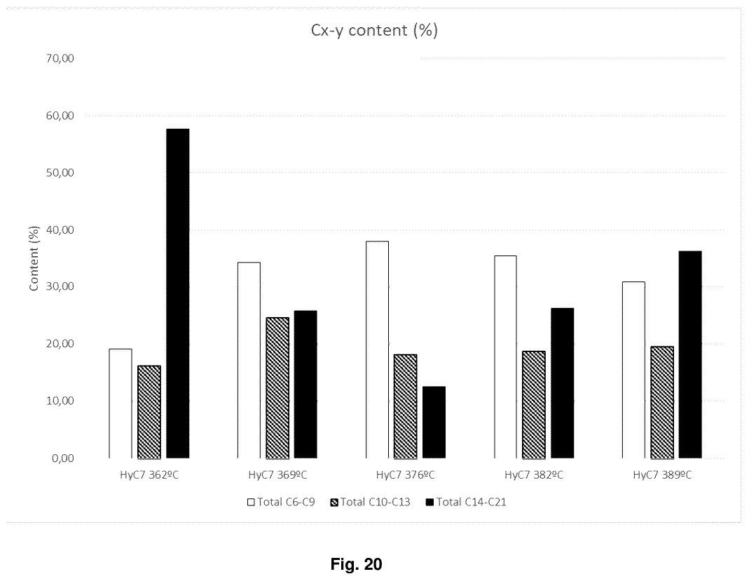

Tables 7 and 8 show how the use of different hydrocracking conditions gave different results in the content of n-paraffins with variations between 36.00% and 52.09%. Something similar occurs with the length of the chains, varying the content of C6-C9 between 19.12% and 38.01% (n-paraffins C6-C9 13.44% and 25.55%), the content of C10-C13 between 16.17% and 24.57% (n-paraffins C10-C13 between 4.41% and 8.40%) and the content of C14-C21 between 12.62% and 57.70% (n-paraffins C14-C21 between 7.32% and 32.39%). See FIGS. 16-20.

The results show that, depending on the selected conditions, it is possible to maximize the content of n-paraffins in the desired chain length range.

TABLE 7
Composition of hydrotreated and hydrocracked products.

| | HVO | HyC7 | HyC7 | HyC7 | HyC7 | HyC7 |
|---|---|---|---|---|---|---|
| | UCO | 362° C. | 369° C. | 376° C. | 382° C. | 389° C. |
| Lighter | | 5.01 | 10.13 | 23.49 | 17.70 | 11.56 |
| Compounds | | | | | | |
| iso C6 | | | | | | |
| nC6 | | 3.97 | 9.32 | 13.68 | 10.99 | 8.88 |
| iso C7 | | 0.00 | 2.49 | 2.73 | 1.96 | 1.43 |
| nC7 | | 3.18 | 6.52 | 3.69 | 6.43 | 6.31 |
| iso C8 | | 2.58 | 0.34 | 3.68 | 1.52 | 2.32 |
| nC8 | 0.73 | 2.89 | 3.73 | 4.18 | 3.97 | 3.82 |
| iso C9 | | 3.10 | 7.46 | 7.33 | 6.41 | 3.88 |
| nC9 | 1.19 | 3.40 | 4.48 | 2.72 | 4.16 | 4.18 |
| iso C10 | | 3.08 | 5.86 | 5.26 | 3.97 | 3.45 |
| nC10 | 0.92 | 2.39 | 3.12 | 1.56 | 2.84 | 2.96 |
| iso C11 | | 2.46 | 4.44 | 3.44 | 3.03 | 2.91 |
| nC11 | 0.55 | 1.47 | 1.90 | 1.26 | 1.82 | 2.13 |
| iso C12 | | 2.55 | 3.97 | 3.34 | 2.78 | 2.89 |
| nC12 | 0.37 | 1.30 | 1.68 | 0.92 | 1.49 | 1.78 |
| iso C13 | | 1.82 | 2.35 | 1.71 | 1.55 | 1.90 |
| nC13 | 0.34 | 1.10 | 1.25 | 0.67 | 1.27 | 1.53 |
| iso C14 | | 1.82 | 2.45 | 1.41 | 1.72 | 1.63 |
| nC14 | 0.34 | 1.41 | 1.33 | 1.74 | 1.06 | 1.48 |
| iso C15 | | 2.81 | 2.61 | 0.68 | 2.30 | 2.72 |
| nC15 | 9.26 | 7.27 | 3.81 | 4.21 | 3.76 | 5.74 |
| iso C16 | | 5.78 | 4.06 | 1.30 | 2.95 | 3.57 |
| nC16 | 5.94 | 3.73 | 1.90 | 1.11 | 1.99 | 2.89 |
| iso C17 | | 9.64 | 3.34 | 1.30 | 4.06 | 5.36 |
| nC17 | 46.86 | 14.94 | 3.84 | 0.26 | 4.20 | 7.27 |
| iso C18 | | 4.03 | 1.26 | 0.40 | 1.96 | 2.63 |
| nC18 | 27.51 | 4.50 | 1.01 | 0.00 | 1.47 | 1.70 |
| iso C19 | | 0.64 | 0.07 | 0.14 | 0.52 | 0.72 |
| nC19 | 0.00 | 0.40 | 0.06 | 0.00 | 0.05 | 0.02 |
| iso C20 | | 0.59 | 0.03 | 0.07 | 0.20 | 0.51 |
| nC20 | 0.00 | 0.14 | 0.00 | 0.00 | 0.03 | 0.03 |

TABLE 8
Composition of hydrotreated and hydrocracked products.

| | | HyC7 | HyC7 | HyC7 | HyC7 | HyC7 |
|---|---|---|---|---|---|---|
| | HVO | 362° | 369° | 376° | 382° | 389° |
| | UCO | C. | C. | C. | C. | C. |
| Total n-parafins | 94.01 | 52.09 | 43.95 | 36.00 | 45.53 | 50.72 |
| Total iso-parafins | 0.00 | 40.90 | 40.73 | 32.79 | 34.93 | 35.92 |
| n-parafins C6-C9 | 1.92 | 13.44 | 24.05 | 24.27 | 25.55 | 23.19 |
| iso-parafins C6-C9 | 0.00 | 5.68 | 10.29 | 13.74 | 9.89 | 7.63 |
| Total C6-C9 | 1.92 | 19.12 | 34.34 | 38.01 | 35.44 | 30.82 |
| n-parafins C10-C13 | 2.18 | 6.26 | 7.95 | 4.41 | 7.42 | 8.40 |
| iso-parafins C10-C13 | 0.00 | 9.91 | 16.62 | 13.75 | 11.33 | 11.15 |
| Total C10-C13 | 2.18 | 16.17 | 24.57 | 18.16 | 18.75 | 19.55 |
| n-parafins C14-C21 | 89.91 | 32.39 | 11.95 | 7.32 | 12.56 | 19.13 |
| iso-parafins C14-C21 | 0.00 | 25.31 | 13.82 | 5.30 | 13.71 | 17.14 |
| Total C14-C21 | 89.91 | 57.70 | 25.77 | 12.62 | 26.27 | 36.27 |

1. A process for producing a n-paraffinic hydrocarbon fraction from an oxygenate feedstock comprising:
a. combining the feedstock with an amount of a hydrocracked intermediate product or another quenching product to form a combined feedstock, directing the combined feedstock to contact a material catalytically active in hydrodeoxygenation (HDO) under hydrodeoxygenation conditions to provide a hydrodeoxygenated intermediate product,
b. fractionating at least an amount of said hydrodeoxygenated intermediate product, optionally combined with an amount of hydrocracked intermediate product, in
b1. at least two fractions, including a first fraction of which at least 90% boils above a defined boiling point, a second fraction of which at least 90% boils below said defined boiling point and an optional naphtha fraction, or
b2. at least three fractions, including a first fraction of which at least 90% boils above a defined higher boiling point, a second fraction of which at least 90% boils below said defined higher boiling point and at least 90% boils above a defined lower boiling point, a third fraction of which at least 90% boils below said defined lower boiling point and an optional naphtha fraction;
c. directing at least an amount of said first fraction to contact a material catalytically active in hydrocracking (HDC) under hydrocracking conditions to provide the hydrocracked intermediate product, wherein said hydrocracked intermediate product is either,
c1. combined with the oxygenate feedstock to form the combined feedstock as defined in step a, or
c2. combined with the hydrodeoxygenated intermediate product as defined in step b, or
c3. split into the two fractions of hydrocracked intermediate product, wherein the hydrocracked intermediate product is combined with the oxygenate feedstock to form the combined feedstock as defined in step a and the hydrocracked intermediate product is combined with the hydrodeoxygenated intermediate product as defined in step b,
d. if the step b is as defined in b1, optionally splitting the second fraction into at least two fractions, and
e. separating the fraction to provide the n-paraffinic rich hydrocarbon fraction of a defined carbon range and an iso-paraffinic rich hydrocarbon fraction.

2. The process according to claim 1, wherein
either at least an amount of the naphtha fraction and at least an amount of the iso-paraffinic rich hydrocarbon fraction are combined,
or at least two fractions selected from at least an amount of the fraction, at least an amount of the naphtha fraction and at least an amount of the iso-paraffinic rich hydrocarbon fraction are combined,
and the resulting product is suitable, without being hydroisomerized and/or hydrodearomatized, for use as jet fuel or as a jet fuel blend component.

3. The process according to claim 1, wherein at least an amount of the fraction, optionally combined with at least an amount of the naphtha fraction, is directed to contact a material catalytically active in hydroisomerization (HDI) under hydroisomerization conditions and a material active in hydrodearomatization (HDA) under hydrodearomatization conditions or is directed to contact a material catalytically active in hydroisomerization (HDI) under hydroisomerization conditions and in hydrodearomatization (HDA) under hydrodearomatization conditions to provide a hydroisomerized and hydrodearomatized product which is optionally combined with at least an amount of the iso-paraffinic hydrocarbon fraction and/or an external iso-paraffinic rich hydrocarbon fraction not deriving from the hydrodeoxygenated intermediate product and/or at least an amount of the naphtha fraction to provide a hydrocarbon product, wherein said product or is suitable for use as jet fuel or as a jet fuel blend component.

4. The process according to claim 1, wherein at least an amount of the fraction and/or an external paraffin fraction not deriving from the hydrodeoxygenated intermediate product, optionally combined with at least an amount of the iso-paraffinic hydrocarbon fraction and/or with at least an amount of the naphtha fraction to form a combined fraction, is directed to contact a material catalytically active in hydroisomerization (HDI) under hydroisomerization conditions and a material active in hydrodearomatization (HDA) under hydrodearomatization conditions or is directed to contact a material catalytically active in hydroisomerization (HDI) under hydroisomerization conditions and in hydrodearomatization (HDA) under hydrodearomatization conditions to provide a hydroisomerized and/or hydrodearomatized product which is optionally combined with at least an amount of the naphtha fraction to provide a hydrocarbon product, wherein said product is suitable for use as jet fuel or as a jet fuel blend component.

5. The process according to claim 3, wherein the hydroisomerized and hydrodearomatized product comprises less than 1 wt/wt %, 0.5 wt/wt % or 0.1 wt/wt %, calculated by total mass of aromatic molecules relative to all hydrocarbons in the stream.

6. The process according to claim 1, wherein step b1 comprises separating the hydrodeoxygenated intermediate product according to boiling point, to provide an intermediate jet product having T10 above 205° C. and final boiling point below 300° C. according to ASTM D86.

7. The process according to claim 1, wherein step b2 comprises separating the hydrodeoxygenated intermediate product according to boiling point, to provide a lighter intermediate jet product and a heavier intermediate jet product, both having T10 above 205° C. and final boiling point below 300° C. according to ASTM D86.

8. The process according to claim 1, wherein the total volume of hydrogen sulfide relative to the volume of molecular hydrogen in the gas phase of the total stream directed to contact the material catalytically active in hydrodeoxygenation is at least 50 ppmᵥ, 100 ppmᵥ or 200 ppmᵥ, possibly originating from an added stream comprising one or more sulfur compounds, such as dimethyl disulfide or fossil fuels.

9. The process according to claim 1, wherein said feedstock comprises a natural oil or fat, said feedstock preferably comprising at least 50% wt triglycerides or fatty acids.

10. The process according to claim 1, wherein hydrodeoxygenation conditions involve a temperature in the interval 250-400° C., a pressure in the interval 30-150 Bar, and a liquid hourly space velocity (LHSV) in the interval 0.1-2.2 and wherein the material catalytically active in hydrodeoxygenation comprises molybdenum or possibly tungsten, optionally in combination with nickel and/or cobalt, supported on a carrier comprising one or more refractory oxides, such as alumina, silica or titania.

11. The process according to claim 1, wherein hydrocracking conditions involve a temperature in the interval 250-410° C., a pressure in the interval 30-150 Bar, and a liquid hourly space velocity (LHSV) in the interval 0.5-4, optionally together with intermediate cooling by quenching with cold hydrogen, feed or product and wherein the material catalytically active in hydrocracking comprises (a) one or more active metals taken from the group platinum, palladium, nickel, cobalt, tungsten and molybdenum, (b) an acidic support taken from the group of a molecular sieve showing high cracking activity, and having a topology such as MFI, BEA and FAU and amorphous acidic oxides and (c) a refractory support, such as alumina, silica or titania, or combinations thereof.

12. The process according to claim 1 wherein the process conditions are selected such that the conversion, defined as the difference in the amount of material boiling above 300° C. in said hydrocracked intermediate product and the amount of material boiling above 300° C. in said fraction, relative to the amount of material boiling above 300° C. in said first fraction, is above 20%, 50% or 80%.

13. The process according to claim 3, wherein hydrodearomatization conditions involve a temperature in the interval 200-350° C., a pressure in the interval 20-100 Bar, and a liquid hourly space velocity (LHSV) in the interval 0.5-8 and wherein said material catalytically active in hydrodearomatization comprises an active metal taken from the group comprising platinum, palladium, nickel, cobalt, tungsten and molybdenum, preferably one or more elemental noble metals such as platinum or palladium and a refractory support, preferably amorphous silica-alumina, alumina, silica or titania, or combinations thereof.

14. The process according to claim 3 wherein a hydrogen rich stream comprising at least 90 vol/vol % hydrogen is directed to contact the material catalytically active in hydrodearomatization (HDA).

15. The process according to claim 3, wherein hydroisomerization conditions involves a temperature in the interval 250-350° C., a pressure in the interval 20-100 Bar, and a liquid hourly space velocity (LHSV) in the interval 0.5-8 and wherein the material catalytically active in isomerization comprises an active metal taken from the group comprising platinum, palladium, nickel, cobalt, tungsten and molybdenum, preferably one or more elemental noble metals such as platinum or palladium, an acidic support preferably a molecular sieve, more preferably having a topology taken from the group comprising MOR, FER, MRE, MWW, AEL, TON and MTT and an amorphous refractory support comprising one or more ox-ides taken from the group comprising alumina, silica and titania.

16. The process according to claim 3 wherein the treated product is directed to a gas/liquid separator to provide a gaseous fraction and a treated intermediate jet product which is directed to a further means of separation, to provide said hydrocarbon fraction suitable for use as a jet fuel or as jet fuel blend component and a treated product off gas or
the process according to claim 2 wherein the resulting product is directed to a gas/liquid separator to provide a gaseous fraction and a treated intermediate jet product which is directed to a further means of separation, to provide said hydrocarbon fraction suitable for use as a jet fuel or as jet fuel blend component and a treated product off gas.

17. A process plant for producing a n-paraffinic hydrocarbon fraction from an oxygenate feedstock, said process plant comprising a hydrodeoxygenation section (HDO), a hydrocracking section (HDC), a fractionation section (FRAC), and a separator section (N/I SEP) said process plant being configured for
a. directing the feedstock and an amount of a hydrocracked intermediate product or another quenching product to the hydrodeoxygenation section (HDO) to provide a hydrodeoxygenated intermediate product,
b. directing the hydrodeoxygenated intermediate product and optionally an amount of hydrocracked intermediate product to said fractionation section (FRAC) to provide
b1. at least two fractions, including a high boiling product fraction and a low boiling product fraction, or
b2. at least three fractions, including a high boiling product fraction, an intermediate boiling product fraction and a low boiling product fraction (227),
c. directing at least an amount of the high boiling product fraction to the hydrocracking section (HDC) to provide a hydrocracked intermediate product, which is either
c1. directed to the hydrodeoxygenation section (HDO) as defined in step a, or
c2. directed to the fractionation section (FRAC) as defined in step b, or
c3. split into the two fractions of hydrocracked intermediate product, wherein the hydrocracked intermediate product is directed to the hydrodeoxygenation section (HDO) as defined in step a and the hydrocracked intermediate product is directed to the fractionation section (FRAC) as defined in step b,
d. if the step b is as defined in b1, optionally splitting the low boiling product fraction in at least two fractions, and
e. directing the fraction to the separator section (N/I SEP) to provide a n-paraffinic rich hydrocarbon fraction of a defined carbon range and an iso-paraffinic rich hydrocarbon fraction.
